(19) United States
(12) Patent Application Publication
(10) Pub. No.: US 2025/0330655 A1
(43) Pub. Date: Oct. 23, 2025

(54) ENCODING METHOD AND APPARATUS, DECODING METHOD AND APPARATUS, ENCODING DEVICE, DECODING DEVICE, AND STORAGE MEDIUM

(71) Applicant: GUANGDONG OPPO MOBILE TELECOMMUNICATIONS CORP., LTD., Dongguan (CN)

(72) Inventor: Zhihuang XIE, Dongguan (CN)

(73) Assignee: GUANGDONG OPPO MOBILE TELECOMMUNICATIONS CORP., LTD., Dongguan (CN)

(21) Appl. No.: 19/256,931

(22) Filed: Jul. 1, 2025

Related U.S. Application Data
(63) Continuation of application No. PCT/CN2023/070109, filed on Jan. 3, 2023.

(51) Int. Cl. H04N 19/82; H04N 19/117; H04N 19/159; H04N 19/174; H04N 19/189; H04N 19/96

(52) U.S. Cl. CPC H04N 19/82; H04N 19/117; H04N 19/159; H04N 19/174; H04N 19/189; H04N 19/96

(57) ABSTRACT

A decoding method includes: decoding a bitstream to determine a related syntax element of a current coding tree unit; determining a geometric transformation type of the current coding tree unit according to the related syntax element; determining reference sample information of the current coding tree unit; performing geometric transformation on the reference sample information of the current coding tree unit according to the geometric transformation type, to obtain geometric transformed reference sample information; inputting the geometric transformed reference sample information of the current coding tree unit to a neural network based in-loop filter model for filtering, to output filtered reconstructed sample information; and performing inverse geometric transformation on the filtered reconstructed sample information according to the geometric transformation type, to obtain final reconstructed sample information of the current coding tree unit.

### CROSS-REFERENCE TO RELATED APPLICATIONS

This application is a continuation of International Application No. PCT/CN2023/070109, filed on Jan. 3, 2023, the disclosure of which is hereby incorporated by reference in its entirety.

### TECHNICAL FIELD

Embodiments of the present disclosure relate to the field of video coding technologies, and in particular, to a coding method and apparatus, an encoding device, a decoding device, and a storage medium.

### BACKGROUND

With increasing requirements on video display quality, new video applications such as high-definition videos and ultra-high-definition videos are developed. The International Standardization Organization (ISO/IEC) and the ITU-T Joint Video Research Team (JVET) have established the next-generation video coding standard H.266/versatile video coding (VVC).

Currently, neural networks are introduced in the video coding field. Due to the powerful learning capability of a neural network, a neural network-based coding tool often has high efficiency in coding. For example, among a neural network-based intra prediction method, a neural network-based inter prediction method, and a neural network based in-loop filtering method, the coding performance of the neural network based in-loop filtering method is most significant. However, the current neural network-based in-loop filtering method does not fully take advantage of a neural network model. In some coding scenarios, the neural network based in-loop filtering method may not improve the filtering effect greatly, or even makes filtering efficiency worse. Therefore, the neural network-based in-loop filtering method needs to be optimized.

### SUMMARY

Embodiments of the present disclosure provide a coding method and apparatus, an encoding device, a decoding device, and a storage medium.

According to a first aspect, an embodiment of the present disclosure provides a decoding method, including:
decoding a bitstream to determine a related syntax element of a current coding tree unit;
determining a geometric transformation type of the current coding tree unit according to the related syntax element;
determining reference sample information of the current coding tree unit, wherein the reference sample information at least comprises predicted sample information and/or reconstructed sample information of the current coding tree unit;
performing geometric transformation on the reference sample information of the current coding tree unit according to the geometric transformation type, to obtain geometric transformed reference sample information;
inputting the geometric transformed reference sample information of the current coding tree unit to a neural network based in-loop filter model for filtering, to output filtered reconstructed sample information; and
performing inverse geometric transformation on the filtered reconstructed sample information according to the geometric transformation type, to obtain final reconstructed sample information of the current coding tree unit.

According to a second aspect, an embodiment of the present disclosure provides an encoding method, including:
determining reference sample information of a current coding tree unit, wherein the reference sample information at least comprises predicted sample information and/or reconstructed sample information of the current coding tree unit;
performing geometric transformation on the reference sample information of the current coding tree unit according to candidate geometric transformation types, to obtain geometric transformed reference sample information;
inputting the geometric transformed reference sample information of the current coding tree unit to a neural network based in-loop filter model for filtering, to output filtered reconstructed sample information;
performing inverse geometric transformation on the filtered reconstructed sample information according to the candidate geometric transformation types, to obtain final reconstructed sample information of the current coding tree unit;
determining a first distortion cost value of the current coding tree unit according to original sample information and the final reconstructed sample information of the current coding tree unit;
determining a geometric transformation type of the current coding tree unit according to first distortion cost values of the current coding tree unit respectively corresponding to the candidate geometric transformation types; and
encoding a related syntax element to the geometric transformation type of the current coding tree unit, and writing an encoded bit into a bitstream.

According to a third aspect, an embodiment of the present disclosure provides a decoding apparatus, including:
a decoding unit, configured to decode a bitstream to determine a related syntax element of a current coding tree unit;
a first determining unit, configured to determine a geometric transformation type of the current coding tree unit according to the related syntax element;
a second determining unit, configured to determine reference sample information of the current coding tree unit, wherein the reference sample information at least comprises predicted sample information and/or reconstructed sample information of the current coding tree unit;
a geometric transformation unit, configured to perform geometric transformation on the reference sample information of the current coding tree unit according to the geometric transformation type, to obtain geometric transformed reference sample information;
a filtering unit, configured to input the geometric transformed reference sample information of the current coding tree unit to a neural network based in-loop filter model for filtering, to output filtered reconstructed sample information; and
an inverse geometric transformation unit, configured to perform inverse geometric transformation on the filtered reconstructed sample information according to the geometric transformation type, to obtain final reconstructed sample information of the current coding tree unit.

According to a fourth aspect, an embodiment of the present disclosure provides an encoding apparatus, including:
a first determining unit, configured to determine reference sample information of a current coding tree unit, wherein the reference sample information at least comprises predicted sample information and/or reconstructed sample information of the current coding tree unit;
a geometric transformation unit, configured to perform geometric transformation on the reference sample information of the current coding tree unit according to candidate geometric transformation types, to obtain geometric transformed reference sample information;
a filtering unit, configured to input the geometric transformed reference sample information of the current coding tree unit to a neural network based in-loop filter model for filtering, to output filtered reconstructed sample information;
an inverse geometric transformation unit, configured to perform inverse geometric transformation on the filtered reconstructed sample information according to the candidate geometric transformation types, to obtain final reconstructed sample information of the current coding tree unit;
a second determining unit, configured to determine a first distortion cost value of the current coding tree unit according to original sample information and the final reconstructed sample information of the current coding tree unit; and determine a geometric transformation type of the current coding tree unit according to first distortion cost values of the current coding tree unit respectively corresponding to the candidate geometric transformation types; and
an encoding unit, configured to encode a related syntax element to the geometric transformation type of the current coding tree unit, and write an encoded bit into a bitstream.

According to a fifth aspect, an embodiment of the present disclosure further provides a decoding device, including a first memory and a first processor, where the first memory stores a computer program executable by the first processor, and when executing the program, the first processor implements the decoding method of a decoder.

According to a sixth aspect, an embodiment of the present disclosure further provides an encoding device, including a second memory and a second processor, where the second memory stores a computer program executable by the second processor, and when executing the program, the second processor implements the encoding method of an encoder.

According to a seventh aspect, an embodiment of the present disclosure provides a computer readable storage medium, where the computer readable storage medium stores a computer program, and when the computer program is executed by a first processor, the decoding method of a decoder is implemented; or when the computer program is executed by the second processor, the encoding method of an encoder is implemented.

### BRIEF DESCRIPTION OF DRAWINGS

FIG. 1 is a schematic diagram of a block diagram of an encoder according to an embodiment of the present disclosure.

FIG. 2 is a schematic diagram of a block diagram of a decoder according to an embodiment of the present disclosure.

FIG. 3 is a schematic flowchart of a decoding method according to an embodiment of the present disclosure.

FIG. 4 is a first schematic diagram of geometric transformation according to an embodiment of the present disclosure.

FIG. 5 is a second schematic diagram of geometric transformation according to an embodiment of the present disclosure.

FIG. 6 is a third schematic diagram of geometric transformation according to an embodiment of the present disclosure.

FIG. 7 is a schematic diagram of a first neural network model according to an embodiment of the present disclosure.

FIG. 8 is a schematic diagram of an attention residual block according to an embodiment of the present disclosure.

FIG. 9 is a schematic diagram of a second neural network model according to an embodiment of the present disclosure.

FIG. 10 is a schematic flowchart of an encoding method according to an embodiment of the present disclosure.

FIG. 11 is a schematic structural diagram of a decoding apparatus according to an embodiment of the present disclosure.

FIG. 12 is a specific schematic structural diagram of hardware of a decoding device according to an embodiment of the present disclosure.

FIG. 13 is a schematic structural diagram of an encoding apparatus according to an embodiment of the present disclosure.

FIG. 14 is a specific schematic structural diagram of hardware of an encoding device according to an embodiment of the present disclosure.

FIG. 15 is a schematic structural diagram of a coding system according to an embodiment of the present disclosure.

### DESCRIPTION OF EMBODIMENTS

To understand features and technical content of the embodiments of the present disclosure in more detail, the following describes implementation of the embodiments of the present disclosure in detail with reference to the accompanying drawings. The accompanying drawings are merely used for description, and are not intended to limit the embodiments of the present disclosure.

Unless otherwise defined, all technical and scientific terms used in the present disclosure have the same meaning as those commonly understood by those skilled in the art of the present disclosure. The terms used in the present disclosure are merely intended to describe the embodiments of the present disclosure, and are not intended to limit present disclosure.

The following description of “some embodiments” means a subset of all possible embodiments, and it may be understood that “some embodiments” may refer to the same or different subsets of all possible embodiments and may be combined with each other without conflict. It should be further noted that the term “first/second/third” in this embodiment of the present disclosure is merely used to distinguish between objects, and does not represent a specific order of the objects. It may be understood that “first/second/third” may interchange in a sequence, so that the embodiments described herein can be implemented in a sequence other than those shown or described herein.

The following describes some embodiments of the present disclosure in detail with reference to the accompanying drawings.

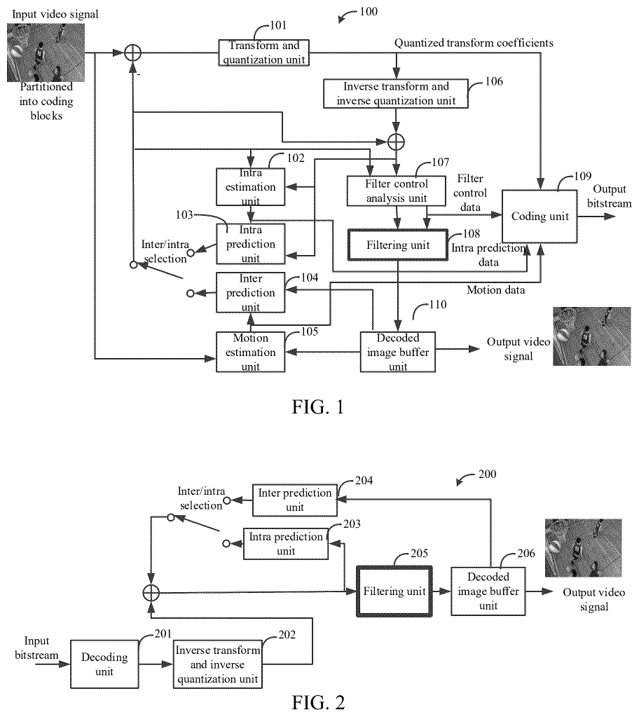

FIG. 1 shows a schematic diagram of an encoder according to an embodiment of the present disclosure. As shown in FIG. 1, the encoder (specifically “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a coding unit 109, and a decoded image buffer unit 110. The filtering unit 108 may implement de-block filtering and sample adaptive offset (SAO) filtering, and the coding unit 109 may implement header information encoding and context-based adaptive binary arithmetic coding (CABAC). For an inputted original video signal, a video coding block may be obtained by means of partitioning into coding tree blocks (CTU), and then residual pixel information obtained after intra or inter prediction is transformed by the transform and quantization unit 101. The transform includes converting residual information from a pixel field to a transform field, and quantize the obtained transform coefficients, so as to further reduce a bit rate. The intra estimation unit 102 and the intra prediction unit 103 are used to perform intra prediction on the video coding block. Specifically, the intra estimation unit 102 and the intra prediction unit 103 are used to determine an intra prediction mode to be used for encoding the video coding block. The motion compensation unit 104 and the motion estimation unit 105 are configured to execute inter prediction encoding on the received video coding block relative to one or more blocks in one or more reference frames to provide time prediction information. The motion estimation executed by the motion estimation unit 105 is a process of generating a motion vector, and the motion vector may be used to estimate a motion of the video coding block, and then the inter prediction unit 104 executes motion compensation based on the motion vector determined by the motion estimation unit 105. Therefore, the inter prediction unit 104 may also be referred to as a motion compensation unit. After determining the intra prediction mode, the intra prediction unit 103 is further configured to provide the selected intra prediction data to the coding unit 109, and the motion estimation unit 105 also sends the calculated motion vector data to the coding unit 109. In addition, the inverse transform and inverse quantization unit 106 is used to reconstruct the video coding block, which reconstructs the residual block in the pixel domain. The reconstructed residual block is processed by the filter control analysis unit 107 and the filter unit 108 to remove the block effect artifact, and then is added to a prediction block in a frame stored in the decoded image buffer unit 110 to generate the reconstructed video coding block. The coding unit 109 is used to encode various encoding parameters and quantized transform coefficients. In the CABAC-based encoding algorithm, context content may be based on adjacent coding blocks, and used to code an indication of the determined intra prediction mode, to output a bitstream of the video signal. The decoded image buffer unit 110 is configured to store the reconstructed video coding block, to be used for prediction reference. As the video image encoding progresses, new reconstructed video coding blocks are continuously generated, and these reconstructed video coding blocks are stored in the decoded image buffer unit 110.

FIG. 2 shows a schematic diagram of a decoder according to an embodiment of this application. As shown in FIG. 2, a decoder (specifically “video decoder”) 200 includes a decoding unit 201, an inverse transform and inverse quantization unit 202, an intra prediction unit 203, a motion compensation unit 204, a filtering unit 205, a decoded image buffer unit 206, and the like. The decoding unit 201 may implement header information decoding and CABAC decoding, and the filtering unit 205 may implement de-block filtering and SAO filtering. After the input video signal is processed by using the encoder in FIG. 1, a bitstream of the video signal is output. The bitstream is inputted to the decoder 200. Firstly, the bitstream is processed by the decoding unit 201 to obtain decoded transform coefficients. The transform coefficients are processed by the inverse transform and inverse quantization unit 202, so as to generate a residual block in the pixel domain. The intra prediction unit 203 may be configured to generate prediction data of the current video decoding block based on the determined intra prediction mode and previously decoded block data from the current frame or picture. The motion compensation unit 204 determines prediction information for the video decoding block by parsing the motion vector and other related syntax element, and uses the prediction information to generate a prediction block for a video decoding block being decoded. A decoded video block is formed by summing the residual block from the inverse transform and inverse quantization unit 202 and the corresponding prediction block generated by the intra prediction unit 203 or the motion compensation unit 204. A decoded video signal passes through the filtering unit 205, so as to remove a block effect artifact, thereby improving video quality. Then, the decoded video block is stored in the decoded image buffer unit 206. The decoded image buffer unit 206 stores a reference image that is used for subsequent intra prediction or motion compensation, and is also used for output of the video signal, to obtain the recovered original video signal.

It should be noted that the method in this embodiment of the present disclosure is mainly applied to the filtering unit 108 shown in FIG. 1 and the filtering unit 205 shown in FIG. 2. That is, embodiments of the present disclosure may be applied to the encoder or the decoder, or may even be applied to both the encoder and the decoder, which is not limited in embodiments of the present disclosure.

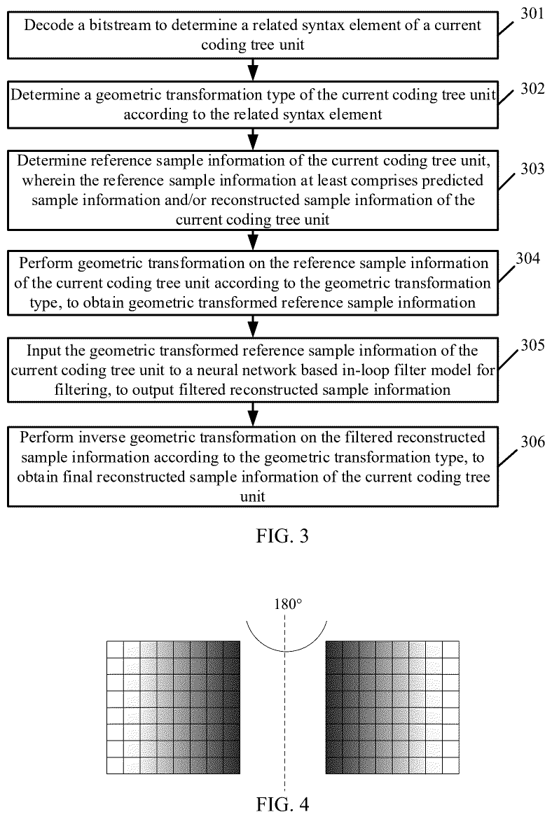

In an embodiment of the present disclosure, referring to FIG. 3, which shows a schematic flowchart of a decoding method according to an embodiment of the present disclosure, the method may include the following steps 301 to 306.

Step 301: Decode a bitstream to determine a related syntax element of a current coding tree unit.

Step 302: Determine a geometric transformation type of the current coding tree unit according to the related syntax element.

The related syntax element is used to indicate the geometric transformation type of the current coding tree unit. The related syntax element includes one or more of a sequence level syntax element, an image level syntax element, a slice level syntax element, or a coding tree unit level syntax element.

Exemplarily, in some embodiments, the related syntax element includes a first syntax element. According to the first syntax element, it is determined whether a current image block in which the current coding tree unit is located uses a neural network based in-loop filtering technology with performing the geometric transformation on an input. If it is determined, according to the first syntax element, to use the neural network based in-loop filtering technology with performing the geometric transformation on an input, the geometric transformation type is further determined; or if it is determined not to use the neural network based in-loop filtering technology with performing the geometric transformation on an input, it is determined that the input is directed inputted to a neural network based in-loop filter model without being processed by the geometric transformation, or it is determined to apply another filtering technology.

Exemplarily, in some embodiments, the current image block includes at least one of the following: an image sequence in which the current coding tree unit is located, an image in which the current coding tree unit is located, a slice in which the current coding tree unit is located, and the current image tree unit. That is, the first syntax element is used to indicate whether the current image block uses the neural network based in-loop filtering technology with performing the geometric transformation on the input.

Exemplarily, the first syntax element includes at least one of the following: an image sequence level first syntax element, used to indicate whether an image sequence uses the neural network based in-loop filtering technology with performing the geometric transformation on the input; an image level first syntax element, used to indicate whether an image uses the neural network based in-loop filtering technology with performing the geometric transformation on the input; a slice level first syntax element, used to indicate whether a slice uses the neural network based in-loop filtering technology with performing the geometric transformation on the input; or a coding tree unit level first syntax element, used to indicate whether a coding tree unit uses the neural network based in-loop filtering technology with performing the geometric transformation on the input.

In some embodiments, the first syntax element includes the image sequence level first syntax element. In some embodiments, the first syntax element includes the image sequence level first syntax element and the image level first syntax element. In some embodiments, the first syntax element includes the image sequence level first syntax element and the slice level first syntax element. In some embodiments, the first syntax element includes the image sequence level first syntax element, the image level (or slice level) first syntax element, and the coding tree unit level first syntax element.

Exemplarily, in some embodiments, the related syntax element includes the first syntax element and a second syntax element. When it is determined, according to the first syntax element, that the current image block in which the current coding tree unit is located uses the neural network based in-loop filtering technology with performing the geometric transformation on the input, it is determined, according to the second syntax element, the geometric transformation type of the coding tree unit in the current image block. That is, the first syntax element is used to indicate using the neural network based in-loop filtering technology with performing the geometric transformation on the input. If there are two or more geometric transformation types, the second syntax element is used to indicate the geometric transformation type. In an actual application, different values are set for a syntax element to indicate different meanings of the syntax element. If there is only one geometric transformation type, the first syntax element is used to indicate using the neural network based in-loop filtering technology with performing the geometric transformation on the input, and may also be used to indicate the geometric transformation type.

Exemplarily, the second syntax element includes one of the following: an image sequence level second syntax element, used to indicate a geometric transformation type of all coding tree units in an image sequence; an image level second syntax element, used to indicate a geometric transformation type of all coding tree units in an image; a slice level second syntax element, used to indicate a geometric transformation type of all coding tree units in a slice; or a coding tree unit level second syntax element, used to indicate a geometric transformation type of a coding tree unit.

For example, in some embodiments, the related syntax element further includes a third syntax element. According to the third syntax element, it is determined whether the current image block uses a neural network based in-loop filtering technology. If determining, according to the third syntax element, to use the neural network based in-loop filtering technology, a related syntax element is parsed subsequently to determine whether to perform a geometric transformation on an input and determine a geometric transformation type. If determining, according to the third syntax element, not to use the neural network based in-loop filtering technology, another filtering technology is used, or no filtering technology is used. In some embodiments, when the third syntax element is of a first preset value, it is determined that none of the coding tree units in the current image block uses the neural network based in-loop filtering technology. When the third syntax element is of a second preset value, it is determined that all coding tree units in the current image block use the neural network based in-loop filtering technology; or when the third syntax element is a second preset value, it is determined that a part of coding tree units in the current image block use the neural network based in-loop filtering technology.

Exemplarily, the third syntax element includes at least one of the following: an image sequence level third syntax element, used to indicate whether an image sequence uses the neural network based in-loop filtering technology; an image level third syntax element, used to indicate whether an image uses the neural network based in-loop filtering technology; a slice level third syntax element, used to indicate whether a slice uses the neural network based in-loop filtering technology; or a coding tree unit level third syntax element, used to indicate whether a coding tree unit uses the neural network based in-loop filtering technology.

In some embodiments, the third syntax element includes the image sequence level third syntax element. In some embodiments, the third syntax element includes the image sequence level third syntax element and the image level third syntax element. In some embodiments, the third syntax element includes the image sequence level third syntax element and the slice level third syntax element. In some embodiments, the third syntax element includes the image sequence level third syntax element, the image level (or slice level) third syntax element of image level, and the coding tree unit level third syntax element.

For example, in some embodiments, the related syntax element further includes a fourth syntax element, and it is determined, according to the fourth syntax element, whether the current image block is allowed to use the neural network based in-loop filtering technology with performing the geometric transformation on the input. If determining, according to the fourth syntax element, that it is allowed to use the neural network based in-loop filtering technology, a related syntax element is parsed subsequently to determine whether to perform a geometric transformation on an input and determine a geometric transformation type. If determining, according to the fourth syntax element, it is not allowed to use the neural network based in-loop filtering technology, another filtering technology is used, or no filtering technology is used.

Exemplarily, in some embodiments, the fourth syntax element includes at least one of the following: an image sequence level fourth syntax element, used to indicate whether an image sequence is allowed to use the neural network based in-loop filtering technology with performing the geometric transformation on the input; an image level fourth syntax element, used to indicate whether an image is allowed to use the neural network based in-loop filtering technology with performing the geometric transformation on the input; a slice level fourth syntax element, used to indicate whether a slice is allowed to use the neural network based in-loop filtering technology with performing the geometric transformation on the input; or a coding tree unit level fourth syntax element, used to indicate whether a coding tree unit is allowed to use the neural network based in-loop filtering technology with performing the geometric transformation on the input.

In some embodiments, the fourth syntax element includes the image sequence level fourth syntax element. In some embodiments, the fourth syntax element includes the image sequence level fourth syntax element and the image level fourth syntax element. In some embodiments, the fourth syntax element includes the image sequence level fourth syntax element and the slice level fourth syntax element. In some embodiments, the fourth syntax element includes the image sequence level fourth syntax element, the image level (or slice level) fourth syntax element, and the coding tree unit level fourth syntax element.

In some embodiments, the related syntax element further includes a fifth syntax element, and it is determined, according to the fifth syntax element, whether the current image block is allowed to use the neural network based in-loop filtering technology. If determining, according to the fifth syntax element, that it is allowed to use the neural network based in-loop filtering technology, a related syntax element is parsed subsequently to determine whether to perform a geometric transformation on an input and determine a geometric transformation type. If determining, according to the fifth syntax element, it is not allowed to use the neural network based in-loop filtering technology, another filtering technology is used, or no filtering technology is used.

In some embodiments, the fifth syntax element includes at least one of the following: an image sequence level fifth syntax element, used to indicate whether an image sequence is allowed to use the neural network based in-loop filtering technology; an image level fifth syntax element, used to indicate whether an image is allowed to use the neural network based in-loop filtering technology; a slice level fifth syntax element, used to indicate whether a slice is allowed to use the neural network based in-loop filtering technology; or a coding tree unit level fifth syntax element, used to indicate whether a coding tree unit is allowed to use the neural network based in-loop filtering technology.

In some embodiments, the fifth syntax element includes the image sequence level fifth syntax element. In some embodiments, the fifth syntax element includes the image sequence level fifth syntax element and an image level fifth syntax element. In some embodiments, the fifth syntax element includes the image sequence level fifth syntax element and the slice level fifth syntax element. In some embodiments, the fifth syntax element includes the image sequence level fifth syntax element, the image level (or slice level) fifth syntax element, and the coding tree unit level fifth syntax element.

Step 303: Determine reference sample information of the current coding tree unit, where the reference sample information at least comprises predicted sample information and/or reconstructed sample information of the current coding tree unit

Exemplarily, as shown in FIG. 1, each image in the input video is partitioned into square largest coding units (LCU) of a same size (such as 128×128, 64×64, etc.). Each largest coding unit may be partitioned into rectangle coding units (CU) according to some rules. The coding unit may be further partitioned into prediction units (PU), transform units (TU), or the like. The hybrid encoding framework includes modules of prediction, transform, quantization, entropy coding, in-loop filtering or the like. The prediction mode module includes intra prediction and inter prediction. Inter prediction includes motion estimation and motion compensation. Since there is a strong correlation between adjacent pixels in an image of a video, an intra prediction method in a video coding technology is used to eliminate spatial redundancy between adjacent pixels. Because of strong similarity between adjacent images in the video, an inter prediction method in the video coding technology is used to eliminate time redundancy between adjacent frames, thereby improving coding efficiency.

The current image is partitioned into blocks, and a prediction block of a current block is generated by the intra prediction or the inter prediction. A prediction block (that is, predicted sample information) of a coding tree unit is formed according to the prediction block of the current block. On the other hand, the bitstream is parsed to obtain the quantized coefficient matrix, the quantized coefficient matrix is inverse quantized and inverse transformed to obtain a residual block, and the prediction block and the residual block are added to obtain a reconstructed block. The reconstructed block forms a reconstructed image (that is, the reconstructed sample information) of the coding tree unit, and the in-loop filtering is performed on the reconstructed image by using the coding tree unit (that is, the largest coding unit) as a basic processing unit to obtain the decoded image.

Exemplarily, in some embodiments, the reference sample information further includes a constant parameter and a non-constant parameter of a current tree coding unit. The constant parameter comprises at least one of the following: a quantization parameter, or an image type or a slice type corresponding to the current coding tree unit. The non-constant parameter includes at least one of the following: boundary strength information of the current coding tree unit, partitioning information of the current coding tree unit, or reconstructed sample information of a coding tree unit that is corresponding to the current coding tree unit and is in a reference image.

The constant parameter may be understood as a parameter common to all pixels in the current coding tree unit. The non-constant parameter may be understood as a parameter not common to all pixels in the current coding tree unit. Performing geometric transformation on the reference sample information of the current coding tree unit includes performing geometric transformation on all non-constant parameters in the reference sample information.

In some embodiments, the method further includes: determining, according to a sixth syntax element, whether to adjust the constant parameter of a current image block in which a current coding tree unit is located; and determining, according to a seventh syntax element, an adjusted constant parameter of the current image block in which the current coding tree unit is located when determining, according to the sixth syntax element, to adjust the constant parameter of the current image block in which the current coding tree unit is located; and adjusting the constant parameter according to an adjustment parameter, and inputting the adjusted constant parameter to the neural network based in-loop filtering technology. In some embodiments, the constant parameter is a quantization parameter.

In some embodiments, the sixth syntax element includes at least one of the following: an image sequence level sixth syntax element, used to indicate whether to adjust the constant parameter of a coding tree unit in an image sequence; an image level sixth syntax element, used to indicate whether to adjust the constant parameter of a coding tree unit in an image; a slice level sixth syntax element, used to indicate whether to adjust the constant parameter of a coding tree unit in a slice; or a coding tree unit level sixth syntax element, used to indicate whether to adjust the constant parameter of a coding tree unit.

In some embodiments, the sixth syntax element includes the image sequence level sixth syntax element. In some embodiments, the sixth syntax element includes the image sequence level sixth syntax element and an image level sixth syntax element. In some embodiments, the sixth syntax element includes the image sequence level sixth syntax element and the slice level sixth syntax element. In some embodiments, the sixth syntax element includes the image sequence level sixth syntax element, the image level (or slice level) sixth syntax element, and the coding tree unit level sixth syntax element.

The seventh syntax element includes one of the following: an image sequence level seventh syntax element, used to indicate an adjusted constant parameter for all coding tree units in an image sequence; a seventh syntax element of an image level, used to indicate an adjusted constant parameter for all coding tree units in an image; a slice level seventh syntax element, used to indicate an adjusted constant parameter for all coding tree units in a slice; or a coding tree unit level seventh syntax element, used to indicate an adjusted constant parameter for a coding tree unit.

In some embodiments, the method further includes: determining, according to the sixth syntax element, a target constant parameter of a current image block in which the current coding tree unit is located. That is, the constant parameter of the current coding tree unit may be directly indicated by using the sixth syntax element. Alternatively, the sixth syntax element indicates whether to adjust the constant parameter of the current coding tree unit. If adjusting the constant parameter, the seventh syntax element is used to indicate the adjustment parameter, and the adjusted constant parameter is determined according to the adjustment parameter.

Step 304: Perform geometric transformation on the reference sample information of the current coding tree unit according to the geometric transformation type, to obtain geometric transformed reference sample information.

For example, the geometric transformation type includes one of the following: diagonal flip, horizontal flip, vertical flip, or rotation by a preset angle.

In the present disclosure, a plurality of geometric transformation model input schemes based on the neural network based in-loop filtering are proposed, that is, information that is to be input into the neural network model is processed by geometric transformation and then is inputted into the model. After inference filtering of the neural network based in-loop filter model, an inverse operation is performed on the output information, and a sample in the output block is converted back to an original position.

Specifically, when horizontal flip needs to be performed on the current input information, vertical coordinates may be fixed, and horizontal coordinates are flipped. As shown in FIG. 4, horizontal flip is performed along a vertical midline of an image.

Assuming that the original model input block has a width patchWidth and a height patchHeight, x represents a horizontal coordinate of a sample, y represents a vertical coordinate of the sample, flip_x represents a horizontal coordinate of the flipped sample, and flip_y represents a vertical coordinate of the flipped sample, the calculation formula of the horizontal flip may be as follows:

$$flip\_x = patchWidth - x ;$$

$$flip\_y = y .$$

The horizontal flip may also be performed not along the vertical midline of the image, but instead along any vertical line of the image.

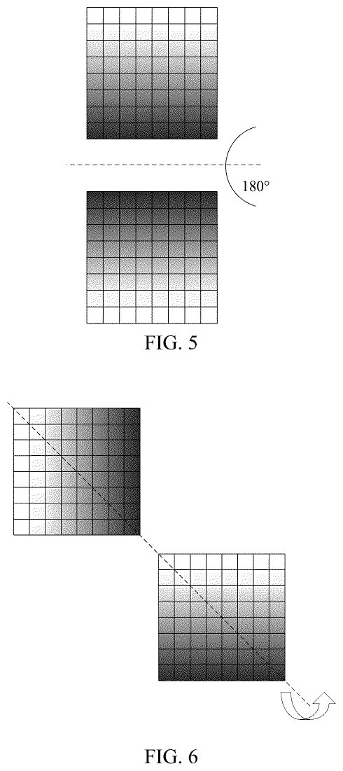

Specifically, when vertical flip is performed on the current input information, horizontal coordinates may be fixed, and vertical coordinates are flipped. As shown in FIG. 5, vertical flip is performed along a horizontal midline of an image.

As described above, assuming that flip_x represents a horizontal coordinate of the flipped sample, and flip_y represents a vertical coordinate of the flipped sample, the calculation formula of the vertical flip may be as follows:

$$flip\_x = x ;$$

$$flip\_y = patchHeight - y .$$

The vertical flip may also be performed not along the horizontal midline of the image, but instead along any horizontal line of the image.

Specifically, when diagonal flip is performed on the current input information, horizontal coordinates and vertical coordinates may be interchanged. Such diagonal flip may also be referred to as diagonal flip along a diagonal line from upper left to lower right, as shown in FIG. 6.

As described above, assuming that x represents a horizontal coordinate of a sample before rotation, y represents a vertical coordinate of the sample before rotation, transpose_x represents a horizontal coordinate of the sample after rotation, and transpose_y represents a vertical coordinate of the sample after rotation, the calculation formula of the diagonal flip may be as follows:

$$transpose\_x = y ;$$

$$transpose\_y = x .$$

Similarly, diagonal flip may also be performed along a diagonal line of the image from upper right to lower left.

In the foregoing three geometric transformations, patchWidth and patchHeight are sizes of a block inputted into the model, which may be the sizes of the coding tree unit, or may be the sizes of a larger patch block obtained by padding outside of a coding tree unit.

Specifically, when the current input information is rotated, a horizontal/vertical midline is used as a rotation axis to rotate by 90, 180, or 270 degrees, or a horizontal/vertical side line is used as a rotation axis to rotate by 90, 180, or 270 degrees, or a diagonal line is used as a rotation axis to rotate by 90, 180, or 270 degrees.

Step 305: Input the geometric transformed reference sample information of the current coding tree unit to a neural network based in-loop filter model for filtering, to output filtered reconstructed sample information.

The neural network based in-loop filter solutions mainly include two types of solutions, one is a switchable multi-model solution, and the other is a single model solution. The two solutions are used as a baseline solution of the neural network based in-loop filter. Subsequently, reference software that combines the two solutions is named as a NNVC (Neural Network based Video Coding reference software). Any proposal related to the neural network needs to be compared with performance and complexity of the NNVC. It should be noted that a basic processing unit for all neural network based in-loop filtering solutions is the coding tree unit, that is, largest coding unit.

The switchable multi-model solution differs from the single-model solution in that the multi-model solution can provide better performance than the single-model solution for different application scenarios or configuration conditions. However, the most obvious disadvantage of the multi-model solution is that multiple models need to be stored, and also a large quantity of models are loaded for calculation and inference.

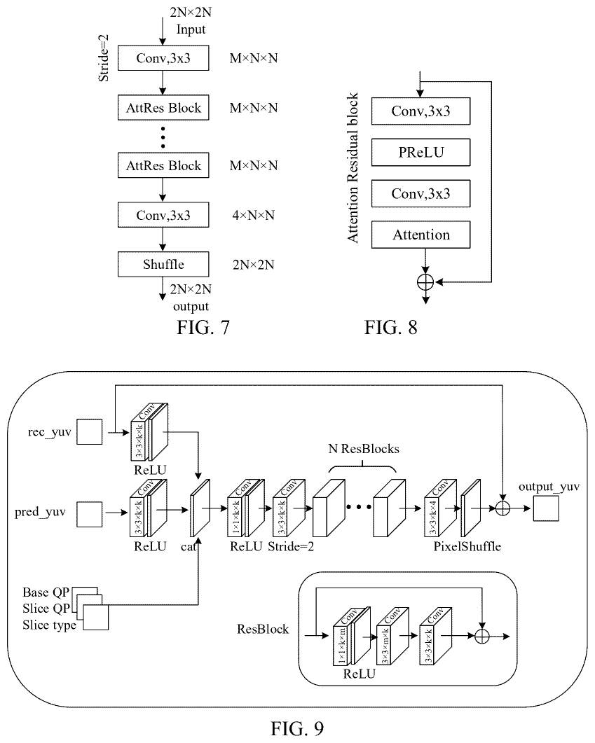

A specific multi-model solution is shown in FIG. 7. The 2N×2N input is usually of a coding tree unit size, but in some specific implementations or methods, the boundary pixels are often copied to outside, which is generally referred to as a padding operation. This is because if a 3×3 convolution neural network as shown in the figure needs to perform convolution operation on the boundary, the block needs to be scaled outside, otherwise the convolution cannot be performed. It is noted that the design of the attention residual block shown in FIG. 8 may vary in different implementations and methods, and the numbers and designs shown herein are merely intended to facilitate understanding of the entire neural network based in-loop filter model framework. The neural network based in-loop filter model framework is mainly formed by an input part “input”, a main network part and an output part “output”. As shown in the figure, the main inference part includes that the 3×3 convolution is connected with multiple ARblocks, and finally, an 3×3 convolution operation is performed and an data shuffle operation is performed.

The attention residual block is a combined block consisting of a plurality of convolution layer Conv., an activation layer PRELU, and an attention mechanism layer Attention. Various operations in the Attention Residual block are not described in detail in the present disclosure. Whether the combined block is used or not, the quantity of the combined block and the internal structure of the combined blocks do not significantly affect the technology to be proposed in the present disclosure. It should be noted that, regardless of whether the attention residual block shown in FIG. 8 is used or another Resblock is used, the solution to be proposed in the present disclosure is applicable.

The input part “input” currently mainly includes reconstructed sample data rec, predicted sample data pred, quantization parameter information QP, border strength information BS, and the like. For different slice types, such as intra I_Slice and dual-reference image B_Slice, different models may be used. Therefore, different input parts may be used. Specifically, for example, the I_Slice model may have an additional input of partition information “partition”. In addition, different models may be applicable for different color components, which may have different input information. For example, a model for the chroma component generally requires not only input of reconstructed sample data rec of the chroma component, but also input of reconstructed sample data rec of the luma component, so as to improve filtering performance.

The output part “output” is basically residual information res of the current coding tree unit or reconstructed sample information rec of the current coding tree unit.

As described above, for different filtering objects such as luma and chroma, the multi-model solution may train a model separately for luma, and then train a model separately for chroma. For example, for the I_Slice and the B_Slice, the multi-model solution may train a model for the I_Slice, and then train a model for the B_Slice separately. Specifically, there are four models in a current mainstream solution, which are respectively corresponding to luma I_Slice, luma B_Slice, chroma I_Slice, and chroma B_Slice.

A specific single model solution is shown in FIG. 9. The input and filtering dimensions of the second solution are the same as those of the first solution, but it is obvious that the combined block used in the solution is different from that used in the first solution, that is, the combined block used herein is ResBlock. As shown in the figure, ResBlock mainly consists of a 1×1×K×K Conv. convolution layer, a ReLU activate layer connected to the 1×1×K×K Conv. convolution layer and a 3×3×K×K Conv. convolution layer. The ARblock in the first solution and the ResBlock in the second solution may include a jumping connection. That is, the input is connected to the output in this combined block.

The input part “input” of the second solution mainly includes a reconstructed sample rec, a predicted sample pred, and reference quantization parameter information BaseQP of three constant inputs, slice level quantization parameter information SliceQP, and a slice type Slicetype. The “slice” herein may be broadly understood as an image level or a picture level. The second solution is a single model, which can process different color components and different image types. Therefore, the input part needs to input the information at one time to help the neural network better filter the current coding tree unit. Therefore, the reconstructed sample rec includes the luma reconstructed sample rec and the chroma reconstructed sample rec, the predicted sample pred includes the luma predicted sample pred and the chroma predicted sample pred, and the slice type Slicetype indicates that the current coding tree unit is of an I_Slice type, a B_Slice type, or another type.

For the output part “output”, if the luma model is used in the first solution, the luma reconstructed sample rec or the luma residual information res is output; or if the chroma model is used, the chroma reconstructed sample rec or the chroma residual information res is output. The second solution is a single model, and thus directly outputs a reconstructed sample rec or residual information res that includes both luma and chroma.

In summary, the main difference between the main frameworks of the two solutions lies in the input part and a quantity of models, and details of the main body part of the neural network are not described in the present disclosure.

In a specific process of training and using the model, because of generalization of the model and the quantization parameter information included in the inputs used for model training, when the model is used to obtain a filtered coding tree unit, different filtering results may be obtained by adjusting parameter information of these inputs. The encoding side selects an optimal parameter according to these different filtering results and a principle of minimum rate distortion, write it into a bitstream of a slice level or a coding tree unit (CTU) level, and transmit the bitstream. The decoding side obtains the adjustment parameter information by parsing the bitstream, and performs a same adjustment operation as that at the encoding side, to obtain a same filtering result as that at the encoding side. This part can be summarized as model input parameter adjustment.

In addition, a scaling operation is generally performed on the filtered reconstructed sample rec. In addition, a scaling factor is obtained by the encoding side by calculating a global minimum mean square error or by calculating another variance to obtain the minimum difference between the original sample, the reconstructed samples before and after filtering by the neural network. The scaling factor is written into a bitstream of the slice level, the CTU level, or another partitioning level, and transmitted to the decoding side. The decoding side obtains, by parsing the bitstream, the same scaling factor as that at the encoding side, and performs scaling on the filtered reconstructed sample, to obtain the final reconstructed sample rec of the coding tree unit. The scaling operation is as follows:

$$r e {c}_{refine} = ( {rec}_{cnn} - {rec}_{before} ) * scale\_factor + {rec}_{before}$$

Where rec_{refine} is a scaled reconstructed sample, rec_{cnn} is a reconstructed sample after being filtered by the neural network, rec_{before} is a reconstructed sample before being filtered by the neural network, and scale_factor is the scaling factor. It should be noted that the foregoing is a theoretical calculation process, and a specific implementation includes replacing a multiplication operation with some shift operations.

As described above, the geometric transformation of the input reference sample information may be used for all non-constant inputs. Specifically, the second neural network based in-loop filtering solution described above is used as an example. As shown in FIG. 9, the model input information includes a reconstructed sample rec, a predicted sample pred, an image or slice type Slicetype, quantization parameter information BaseQP and SliceQP, where only the reconstructed sample rec and predicted sample pred are non-constant information, while the image or slice type Slicetype, the quantization parameter BaseQP and quantization parameter SliceQP are typically constants in in-loop filtering based on coding tree units, that is, the same constant is used for all locations. Therefore, taking the second neural network based in-loop filtering solution as an example, if a geometric transformation needs to be performed, only the reconstructed sample rec and the predicted sample pred are flipped or rotated.

If using the first neural network based in-loop filtering solution described in the foregoing as an example, input information is different for different neural network based in-loop filter models. In addition to performing geometric transformation on the reconstructed sample rec and the predicted sample pred, the boundary strength information BS and the partition information “part” need to be geometric transformed.

It should be noted that input information of the model described in the present disclosure may not cover all input information. For example, in some applications or solutions, inputs of the neural network based in-loop filter model may include information of a co-location coding tree unit in a reference image or other non-constant information, which can also use the geometric transformation method proposed in the present disclosure.

Step 306: Perform inverse geometric transformation on the filtered reconstructed sample information according to the geometric transformation type, to obtain final reconstructed sample information of a current coding tree unit.

Exemplarily, in some embodiments, the method further includes: in a case that a time domain level of the current coding tree unit is greater than or equal to a time domain level threshold, determining the geometric transformation type of the current coding tree unit according to the related syntax element; in a case that the time domain level of the current coding tree unit is less than the time domain level threshold, determining not to use a neural network based in-loop filtering technology with performing the geometric transformation on an input.

Exemplarily, in some embodiments, the current coding tree unit is a largest coding unit, or is obtained by changing a size of a largest coding unit. That is, in the foregoing geometric transformation, patchWidth and patchHeight are sizes of a block inputted into the model, which may be the sizes of the coding tree unit, or may be the sizes of a larger patch block obtained by padding outside of a coding tree unit.

The methods involving multiple inputs of geometric transformation models proposed in the present disclosure introduce one or more new syntax element in the neural network based in-loop filter solution. The syntax element includes but is not limited to the following:
an image sequence level fourth syntax element, sps_nnlf_geotransform_enable_flag (sequence level enabling flag);
an image level or slice level fourth syntax element, slice_nnlf_geotransform_enable_flag (image level or slice level enabling flag);
an image level or slice level first syntax element, slice_nnlf_geotransform_flag (image level or slice level using flag);
an image level or slice level second syntax element, slice_nnlf_geotransform_index (image level or slice level index);
a coding tree unit level first syntax element, ctb_nnlf_geotransform_flag (coding tree unit level using flag);
a coding tree unit level second syntax element, ctb_nnlf_geotransform_index (coding tree unit level index).

If the same or similar syntax element as sps_nnlf_geotransform_enable_flag is used, it is applicable to the technology provided in the embodiments of the present disclosure. Otherwise, the sequence level flag is not required, and the current sequence is allowed by default to use the techniques described herein.

The decoding side parses the sequence level flag. If sps_nnlf_enable_flag (image sequence level fifth syntax element) is true, it indicates that the neural network based in-loop filtering technology is allowed to be used for the current bitstream, and a related syntax element needs to be parsed in a subsequent decoding process, for example, parsing the bitstream to acquire sps_nnlf_geotransform_enable_flag. Otherwise, it indicates that the neural network based in-loop filtering technology is not allowed to be used in the current bitstream. The decoding process does not need to parse the related syntax element. By default, the related syntax element is of an initial value or a false state.

1. If sps_nnlf_enable_flag is true, the decoder parses the related syntax element to the neural network based in-loop filtering technology for the current image or slice to obtain an image level or slice level flag slice_nnlf_flag (that is, the image level or slice level third syntax element) of the neural network based in-loop filtering technology. Otherwise, all flags related to the neural network in-loop filtering in the sequence level are set to default values, and step 3 is performed.

If sps_nnlf_enable_flag is true and the current image or slice is allowed to use multiple geometric transformation model input technologies proposed in the present disclosure and slice_nnlf_flag is not 0, the decoder parses the current image level or slice level syntax element related to the technology described in the present disclosure to obtain the image level or slice level flag slice_nnlf_geotransform_flag. Otherwise, slice_nnlf_geotransform_flag is set to false. If slice_nnlf_geotransform_flag is true, bitstream needs to be further parsed to obtain an index value of a current image level or slice level syntax element slice_nnlf_geotransform_index.

2. If slice_nnlf_flag is 0, it indicates that no coding tree unit in the current image or slice uses the neural network based in-loop filtering technology, and step 3 is performed.

If slice_nnlf_flag is 1, it indicates that all the coding tree units in the current image or slice are filtered by using the neural network based in-loop filtering technology, and flags ctb_nnlf_flag of all the coding tree units in the current image or slice are set to true. All coding tree units in the current image or slice are filtered and a neural network based in-loop filter model applicable to the current image, slice or coding tree unit is 1 loaded. If slice_nnlf_geotransform_flag is true, geometric transformation needs to be performed on the non-constant input of the model, and a type of the transformation is determined by slice_nnlf_geotransform_index. In this embodiment, the encoding side and the decoding side have both specified that the index of the horizontal flip is 0, the index of the vertical flip is 1, and the index of the diagonal flip is 2. The corresponding geometric transformation type is selected according to the slice_nnlf_geotransform_index obtained by parsing the bitstream to perform geometric transformation on the reconstructed sample rec and the predicted sample pred, and then, together with the quantization parameter BaseQP, the quantization parameter SliceQP, and the image or slice type SliceType, are inputted to the model for inference filtering, to obtain the residual information or the filtered reconstructed sample of the current coding tree unit. Inverse transformation is performed on the output information of the model to obtain a filtered reconstructed sample of a normal sequence of the current coding tree unit. An inverse transformation type is the same as a transformation type used before being input to the model. A specific method is not described in detail herein.

If slice_nnlf_flag is 2, it indicates that some coding tree units in the current image or slice uses the neural network based in-loop filtering technology, and some other coding tree units in the current image or slice do not use the neural network based in-loop filtering technology. Therefore, the coding tree unit level use flags ctb_nnlf_flag of all the coding tree units in the current image or slice need to be further parsed. A neural network based in-loop filter model corresponding to the current image, slice, or coding tree unit is loaded, and all the coding tree units in the current image or slice are traversed. If ctb_nnlf_flag is true, the coding tree unit is filtered by using the loaded model; and if ctb_nnlf_flag is false, the coding tree unit is not filtered. Geometric transformation is performed on the non-constant information input to the model for filtering according to slice_nnlf_geotransform_flag and slice_nnlf_geotransform_index. Inverse transformation of a same type of geometric transformation is performed on the output information of the model to obtain a filtered reconstructed sample of a current coding tree unit in a normal sequence. A specific coding tree unit level filtering process is the same as the foregoing, and details are not described herein again.

After all the coding tree units in the current image or slice are traversed, the process of the neural network based in-loop filter module ends.

3. The decoding side continues to traverse other in-loop filtering tools and outputs the complete reconstructed image. The specific process is not related to the technology in the present disclosure, and thus is not described in detail herein.

TABLE 1
First brief description of the parsing on the decoding side

| | |
|---|---|
| if (sps_nnlf_enable_flag) | |
| { | |
| sps_nnlf_geotransform_enable_flag | ae(v) |
| slice_nnlf_flag // parsing image level or slice level flag | ae(v) |
| if (slice_nnlf_flag != 0) // using the neural network in-loop filtering | |
| { | |
| if (slice_nnlf_flag == 1) { // all CTUs in the current image or slice are to be | |
| filtered | |
| for (traverse all ctbs){ | |
| ctb_nnlf_flag = 1 // needing not to be parsed, and all setting to be true | |
| by default | |
| } | |
| } // if (slice_nnlf_flag == 1) | |
| else{ // not all CTUs in the current image or chip are to be filtered | |
| for (traverse all ctbs){ | |
| ctb_nnlf_flag // parsing a coding tree unit level flag | ae(v) |
| } | |
| } | |
| if (slice_type == B_Slice && sps_nnlf_geotransform_enable_flag) { // | |
| Herein a condition in which a current image or slice is allowed to use the technology | |
| described herein is assumed to be B_Slice, that is, slice_type == B_Slice. Other condition | |
| may be included, for example, whether a time domain layer level of the current image or | |
| slice meets a preset threshold. | |
| slice_nnlf_geotransform_flag // parsing an image or slice level flag for | ae(v) |
| the technology of the present disclosure | |
| if (slice_nnlf geotransform_flag){ | |
| slice_nnlf_geotransform_index // if using the technology, parsing | ae(v) |
| the geometric transformation type. | |
| } | |
| } | |
| else { | |
| slice_nnlf_geotransform_flag = 0 // the current image or film is not | |
| allowed to use this document technology. | |
| } | |
| } // if (slice_nnlf_flag != 0) The following is the first case. | |
| else { // no coding tree unit in the current image or chip is to be filtered | |
| slice_nnlf_geotransform_flag = 0 // no using the NN filtering technology, and | |
| accordingly not using the present technology. | |
| for (traverse all ctbs){ | |
| ctb_nnlf_flag = 0 // needing not to be parsed, and all setting to be false | |
| by default | |
| } | |
| } | |
| } // sps | |

In this embodiment, the coding tree unit level may have different parameter adjustments, and the parameter adjustments are usually applied to constant inputs of the model. For example, both the introduced first and second neural network based in-loop filter solutions have constant input information, including quantization parameter information, a current image or slice type information, and the like. This embodiment focuses on a coupling application between parameter adjustment of the constant input and the technology provided in the present disclosure, which may be combined.

Specifically, the first neural network based in-loop filter solution is used as an example to adjust the quantization parameter BaseQP that is input into the model according to a preset step size or offset value or compensation value or candidate value. In this embodiment, a compensation value is used as an example, and adjustment calculation is as follows:

$$FinalBaseQP = BaseQP + offset$$

In the foregoing calculation formula, FinalBaseQP is the quantization parameter BaseQP that is finally inputted into the model, and offset is a quantization parameter compensation value (that is, an adjustment parameter), and may be 0, +5,−5, +10,−10, or the like.

If the standard text has the same or similar syntax element as sps_nnlf_geotransform_flag, it is applicable to the technology referred to herein, Otherwise, a sequence level flag is not required by default, that is, the current sequence is allowed to use the technology proposed in the present disclosure by default.

The decoding side parses the sequence level flag. If sps_nnlf_enable_flag is true, it indicates that the current bitstream allows the use of the neural network based in-loop filtering technology and the subsequent decoding process needs to parse the related syntax element, for example, parse the bitstream to obtain the sps_nnlf_geotransform_flag. Otherwise, it indicates that the neural network based in-loop filtering technology is not allowed to be used in the current bitstream. The subsequent decoding process does not need to parse the related syntax element. By default, the related syntax element is of an initial value or a false state.

1. If sps_nnlf_enable_flag is true, the decoder parses the related syntax element to the neural network based in-loop filtering technology for the current image or slice to obtain an image level or slice level flag slice_nnlf_flag of the neural network based in-loop filtering technology. Otherwise, all flags related to the neural network in-loop filtering in the sequence level are set to default values, and step 3 is performed.

If the current image or slice level flag slice_nnlf_flag is not 0, the bitstream is parsed to acquire the current image or slice level flag slice_nnlf_qpadj_flag; otherwise (that is, slice_nnlf_flag is 0), the current image level or slice level flag slice_nnlf_qpadj_flag is set to be false by default. If slice_nnlf_qpadj_flag is true, the bitstream is parsed to obtain the current image or slice level index slice_nnlf_qpadj_index.

If sps_nnlf_enable_flag is true and the current image or slice is allowed to use multiple geometric transformation model input technologies proposed in the present disclosure and slice_nnlf_flag is not 0, the decoder parses the current image level or slice level syntax element related to the technology described in the present disclosure to obtain the image level or slice level flag slice_nnlf_geotransform_flag. Otherwise, slice_nnlf_geotransform_flag is set to false. If slice_nnlf_geotransform_flag is true, bitstream needs to be further parsed to obtain an index value of a current image level or slice level syntax element slice_nnlf_geotransform_index.

2. If slice_nnlf_flag is 0, it indicates that no coding tree unit in the current image or slice uses the neural network based in-loop filtering technology, and step 3 is performed.

If slice_nnlf_flag is 1, it indicates that all the coding tree units in the current image or slice are filtered by using the neural network based in-loop filtering technology, and flags ctb_nnlf_flag of all the coding tree units in the current image or slice are set to true. All coding tree units in the current image or slice are filtered and a neural network based in-loop filter model applicable to the current image, slice or coding tree unit is loaded. If slice_nnlf_qpdj_flag is true, the quantization parameter BaseQP input to the model is adjusted according to the index of slice_nnlf_qpadj_index. Otherwise, the quantization parameter BaseQP does not need to be adjusted. The adjustment process is the same as that of the encoding side. If the index value of slice_nnlf_qpadj_index is 0, BaseQP−5 is the quantization parameter input of the model. If slice_nnlf_qpadj_index is 1, BaseQP+5 is the quantization parameter input of the model. In addition, if slice_nnlf_geotransform_flag is true, geometric transformation needs to be performed on the non-constant input of the model, and a type of the transformation is determined by slice_nnlf_geotransform_index. In this embodiment, the encoding side and the decoding side have both specified that the index of the horizontal flip is 0, the index of the vertical flip is 1, and the index of the diagonal flip is 2. The corresponding geometric transformation type is selected according to the slice_nnlf_geotransform_index obtained by parsing the bitstream to perform geometric transformation on the reconstructed sample rec and the predicted sample pred, and then, together with the quantization parameter BaseQP, the quantization parameter SliceQP, and the image or slice type SliceType, are inputted to the model for inference filtering, to obtain the residual information or the filtered reconstructed sample of the current coding tree unit. Inverse transformation is performed on the output information of the model to obtain a filtered reconstructed sample of a normal sequence of the current coding tree unit. An inverse transformation type is the same as a transformation type used before being input to the model. A specific method is not described in detail herein.

If slice_nnlf_flag is 2, it indicates that some coding tree units in the current image or slice uses the neural network based in-loop filtering technology, and some other coding tree units in the current image or slice do not use the neural network based in-loop filtering technology. Therefore, the coding tree unit level use flags ctb_nnlf_flag of all the coding tree units in the current image or slice need to be further parsed. A neural network based in-loop filter model corresponding to the current image, slice, or coding tree unit is loaded, and all the coding tree units in the current image or slice are traversed. If ctb_nnlf_flag is true, the coding tree unit is filtered by using the loaded model; and if ctb_nnlf_flag is false, the coding tree unit is not filtered. If slice_nnlf_qpdj_flag is true, the quantization parameter BaseQP input to the model is adjusted according to the index of slice_nnlf_qpadj_index. Otherwise, the quantization parameter BaseQP does not need to be adjusted. The adjustment process is the same as that of encoding side. If the index value of slice_nnlf_qpadj_index is 0, BaseQP−5 is the quantization parameter input of the model. If slice_nnlf_qpadj_index is 1, BaseQP+5 is the quantization parameter input of the model. In addition, geometric transformation is performed on the non-constant information input to the model for filtering according to slice_nnlf_geotransform_flag and slice_nnlf_geotransform_index. Inverse transformation of a same type of geometric transformation is performed on the output information of the model to obtain a filtered reconstructed sample of a current coding tree unit in a normal sequence. A specific coding tree unit level filtering process is the same as the foregoing, and details are not described herein again.

After all the coding tree units in the current image or slice are traversed, the process of the neural network based in-loop filter module ends.

3. The decoding side continues to traverse other in-loop filtering tools and outputs the complete reconstructed image. The specific process is not related to the technology in the present disclosure, and thus is not described in detail herein.

TABLE 2
Second brief description of the parsing on the decoding side

| | |
|---|---|
| if (sps_nnlf_enable_flag) | |
| { | |
| sps_nnlf_geotransform_enable_flag | ae(v) |
| slice_nnlf_flag // parsing image level or slice level flag | ae(v) |
| if (slice_nnlf_flag != 0) // using the neural network in-loop filtering | |
| { | |
| if (slice_nnlf_flag == 1) { // all CTUs in the current image or slice are to be | |
| filtered | |
| for (traverse all ctbs){ | |
| ctb_nnlf_flag = 1 // needing not to be parsed, and all setting to be true | |
| by default | |
| } | |
| } // if (slice_nnlf_flag == 1) | |
| else{ // not all CTUs in the current image or chip are to be filtered | |
| for (traverse all ctbs){ | |
| ctb_nnlf_flag // parsing a coding tree unit level flag | ae(v) |
| } | |
| } | |
| slice_nnlf_qpadj_flag // parsing a current image or slice level quantization | ae(v) |
| parameter adjustment flag | |
| if (slice_nnlf qpadj_flag) { | |
| slice_nnlf_qpadj_index // if needing adjustment, parsing a quantization | ae(v) |
| parameter adjustment index | |
| } | |
| if (slice_type == B_Slice && sps_nnlf_geotransform_enable_flag) { // | |
| Herein a condition in which a current image or slice is allowed to use the technology | |
| described herein is assumed to be B_Slice, that is, slice_type == B_Slice. Other condition | |
| may be included, for example, whether a time domain layer level of the current image or | |
| slice meets a preset threshold. | |
| slice_nnlf_geotransform_flag // parsing an image or slice level flag for | ae(v) |
| the technology of the present disclosure | |
| if (slice_nnlf geotransform_flag){ | |
| slice_nnlf_geotransform_index // if using the technology, parsing | ae(v) |
| the geometric transformation type. | |
| } | |
| } | |
| else { | |
| slice_nnlf_geotransform_flag = 0 // the current image or film is not | |
| allowed to use this document technology. | |
| } | |
| } // if (slice_nnlf_flag != 0) The following is the first case. | |
| else { // no coding tree unit in the current image or chip is to be filtered | |
| slice_nnlf_geotransform_flag = 0 // no using the NN filtering technology, and | |
| accordingly not using the present technology. | |
| for (traverse all ctbs){ | |
| ctb_nnlf_flag = 0 // needing not to be parsed, and all setting to be false | |
| by default | |
| } | |
| } | |
| } // sps | |

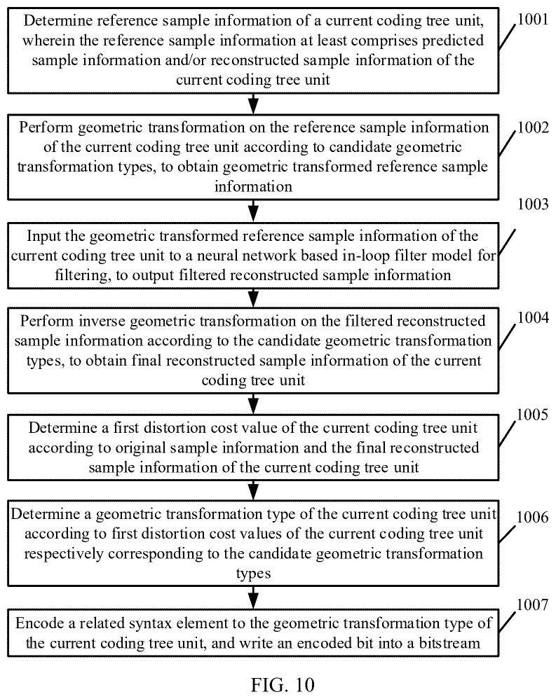

An embodiment of the present disclosure further provides an encoding method. In an embodiment of the present disclosure, referring to FIG. 10, which shows a schematic flowchart of an encoding method according to an embodiment of the present disclosure, the method may include the following steps 1001 to 1007.

Step 1001: Determine reference sample information of a current coding tree unit. The reference sample information at least includes predicted sample information and/or reconstructed sample information of the current coding tree unit.

The current image is partitioned into blocks, and a prediction block of a current block is generated by the intra prediction or the inter prediction. A prediction block (that is, predicted sample information) of a coding tree unit is formed according to the prediction block of the current block. On the other hand, the bitstream is parsed to obtain the quantized coefficient matrix, the quantized coefficient matrix is inverse quantized and inverse transformed to obtain a residual block, and the prediction block and the residual block are added to obtain a reconstructed block. The reconstructed block forms a reconstructed image (that is, the reconstructed sample information) of the coding tree unit, and the in-loop filtering is performed on the reconstructed image by using the coding tree unit (that is, the largest coding unit) as a basic processing unit to obtain the decoded image.

Step 1002: Perform geometric transformation on the reference sample information of the current coding tree unit according to candidate geometric transformation types, to obtain geometric transformed reference sample information.

Herein, the candidate geometric transformation types include at least one geometric transformation type. For example, the geometric transformation types include one of the following: diagonal flip, horizontal flip, vertical flip, or rotation by a preset angle.

Step 1003: Input the geometric transformed reference sample information of the current coding tree unit to a neural network based in-loop filter model for filtering, to output filtered reconstructed sample information.

Step 1004: Perform inverse geometric transformation on the filtered reconstructed sample information according to the candidate geometric transformation types, to obtain final reconstructed sample information of the current coding tree unit.

Step 1005: Determine a first distortion cost value of the current coding tree unit according to original sample information and the final reconstructed sample information of the current coding tree unit.

Step 1006: Determine a geometric transformation type of the current coding tree unit according to first distortion cost values of the current coding tree unit respectively corresponding to the candidate geometric transformation types.

Exemplarily, in some embodiments, the geometric transformation type of the current coding tree unit according to the first distortion cost values of the current coding tree unit respectively corresponding to the candidate geometric transformation types comprises: accumulating first distortion cost values of all coding tree units in a current image block in which the current coding tree unit is located, to determine a first distortion cost value of the current image block; and determining the geometric transformation type of the current coding tree unit according to first distortion cost values of the current image block respectively corresponding to the candidate geometric transformation types. In some embodiments, the first distortion generation value may be a rate distortion cost value.

For example, the current image block includes at least one of the following: a current image sequence, a current image, a current slice, or a current coding tree unit. That is, if the current image block is a current image sequence, a current image, or a current slice, a geometric transformation type of the current image block is determined according to an accumulated value of first distortion cost values of all coding tree units in the current image block. If the current image block is a current coding tree unit, a geometric transformation type of the current coding tree unit is determined according to the first distortion cost value of the current coding tree unit.

Exemplarily, in some embodiments, the method further includes: inputting the reference sample information of the current coding tree unit to a neural network based in-loop filter model for filtering, to output filtered reconstructed sample information; determining a second distortion cost value of the current coding tree unit according to the original sample information of the current coding tree unit and the filtered reconstructed sample information; accumulating second distortion cost values of all coding tree units in a current image block in which the current coding tree unit is located, to determine a second distortion cost value of the current image block; determining a third distortion cost value of the current coding tree unit according to the original sample information and the reconstructed sample information of the current coding tree unit; accumulating third distortion cost values of all coding tree units in the current image block in which the current coding tree unit is located, to determine a third distortion cost value of the current image block; determining a least distortion cost value among the first distortion cost value, the second distortion cost value and the third distortion cost value of the current coding tree unit, as a fourth distortion cost value of the current coding tree unit; accumulating fourth distortion cost values of all coding tree units in the current image block in which the current coding tree unit is located, to determine a fourth distortion cost value of the current image block; and determining, according to a least distortion cost value among the first distortion cost value, the second distortion cost value, the third distortion cost value and the fourth distortion cost value of the current image block, whether the current image block uses a neural network based in-loop filtering technology with performing the geometric transformation on an input, and whether the current image block uses a neural network based in-loop filtering technology.

Step 1007: Encode a related syntax element to the geometric transformation type of the current coding tree unit, and writing an encoded bit into a bitstream.

The related syntax element is used to indicate the geometric transformation type of the current coding tree unit. The related syntax element includes one or more of a sequences level syntax element, an image level syntax element, a slice level syntax element, or a coding tree unit level syntax element.

Exemplarily, in some embodiments, the related syntax element includes a first syntax element. The first syntax element is set according to whether a current image block in which the current coding tree unit is located uses a neural network based in-loop filtering technology with performing the geometric transformation on an input. When determining, according to the first syntax element, to use the neural network based in-loop filtering technology with performing the geometric transformation on the input, a subsequent related syntax element is parsed to determine a geometric transformation type; and When determining, according to the first syntax element, not to use the neural network based in-loop filtering technology with performing the geometric transformation on the input, the geometric transformation is not performed on the input, or another filtering technology is used.

Exemplarily, in some embodiments, the current image block includes at least one of the following: an image sequence in which the current coding tree unit is located, an image in which the current coding tree unit is located, a slice in which the current coding tree unit is located, and the current image tree unit.

Exemplarily, the first syntax element includes at least one of the following: an image sequence level first syntax element, used to indicate whether an image sequence uses the neural network based in-loop filtering technology with performing the geometric transformation on the input; an image level first syntax element, used to indicate whether an image uses the neural network based in-loop filtering technology with performing the geometric transformation on the input; a slice level first syntax element, used to indicate whether a slice uses the neural network based in-loop filtering technology with performing the geometric transformation on the input; or a coding tree unit level first syntax element, used to indicate whether a coding tree unit uses the neural network based in-loop filtering technology with performing the geometric transformation on the input.

In some embodiments, the first syntax element includes the image sequence level first syntax element. In some embodiments, the first syntax element includes the image sequence level first syntax element and the image level first syntax element. In some embodiments, the first syntax element includes the image sequence level first syntax element and the slice level first syntax element. In some embodiments, the first syntax element includes the image sequence level first syntax element, the image level (or slice level) first syntax element, and the coding tree unit level first syntax element.

Exemplarily, in some embodiments, the related syntax element includes the first syntax element and a second syntax element. When determining that the current image block in which the current coding tree unit is located uses the neural network based in-loop filtering technology with performing the geometric transformation on the input, the second syntax element is set according to the geometric transformation type of the coding tree unit in the current image block. That is, the first syntax element is used to indicate using the neural network based in-loop filtering technology with performing the geometric transformation on the input. If there are two or more geometric transformation types, the second syntax element is used to indicate the geometric transformation type. In an actual application, different values are set for a syntax element to indicate different meanings of the syntax element.

Exemplarily, the second syntax element includes one of the following: an image sequence level second syntax element, used to indicate a geometric transformation type of all coding tree units in an image sequence; an image level second syntax element, used to indicate a geometric transformation type of all coding tree units in an image; a slice level second syntax element, used to indicate a geometric transformation type of all coding tree units in a slice; or a coding tree unit level second syntax element, used to indicate a geometric transformation type of a coding tree unit.

For example, in some embodiments, the related syntax element further includes a third syntax element, and the third syntax element is set according to whether the current image block uses a neural network based in-loop filtering technology. If determining, according to the third syntax element, to use the neural network based in-loop filtering technology, a related syntax element is parsed subsequently to determine whether to perform a geometric transformation on an input and determine a geometric transformation type. If determining, according to the third syntax element, not to use the neural network based in-loop filtering technology, another filtering technology is used, or no filtering technology is used.

Exemplarily, the third syntax element includes at least one of the following: an image sequence level third syntax element, used to indicate whether an image sequence uses the neural network based in-loop filtering technology; an image level third syntax element, used to indicate whether an image uses the neural network based in-loop filtering technology; a slice level third syntax element, used to indicate whether a slice uses the neural network based in-loop filtering technology; or a coding tree unit level third syntax element, used to indicate whether a coding tree unit uses the neural network based in-loop filtering technology.

In some embodiments, the third syntax element includes the image sequence level third syntax element. In some embodiments, the third syntax element includes the image sequence level third syntax element and the image level third syntax element. In some embodiments, the third syntax element includes the image sequence level third syntax element and the slice level third syntax element. In some embodiments, the third syntax element includes the image sequence level third syntax element, the image level (or slice level) third syntax element of image level, and the coding tree unit level third syntax element.

For example, in some embodiments, the related syntax element further includes a fourth syntax element, and the fourth syntax element is set according to whether the current image block is allowed to use the neural network based in-loop filtering technology with performing the geometric transformation on the input. If determining, according to the fourth syntax element, that it is allowed to use the neural network based in-loop filtering technology, a related syntax element is parsed subsequently to determine whether to perform a geometric transformation on an input and determine a geometric transformation type. If determining, according to the fourth syntax element, it is not allowed to use the neural network based in-loop filtering technology, another filtering technology is used, or no filtering technology is used.

Exemplarily, in some embodiments, the fourth syntax element includes at least one of the following: an image sequence level fourth syntax element, used to indicate whether an image sequence is allowed to use the neural network based in-loop filtering technology with performing the geometric transformation on the input; an image level fourth syntax element, used to indicate whether an image is allowed to use the neural network based in-loop filtering technology with performing the geometric transformation on the input; a slice level fourth syntax element, used to indicate whether a slice is allowed to use the neural network based in-loop filtering technology with performing the geometric transformation on the input; or a coding tree unit level fourth syntax element, used to indicate whether a coding tree unit is allowed to use the neural network based in-loop filtering technology with performing the geometric transformation on the input.

In some embodiments, the fourth syntax element includes the image sequence level fourth syntax element. In some embodiments, the fourth syntax element includes the image sequence level fourth syntax element and the image level fourth syntax element. In some embodiments, the fourth syntax element includes the image sequence level fourth syntax element and the slice level fourth syntax element. In some embodiments, the fourth syntax element includes the image sequence level fourth syntax element, the image level (or slice level) fourth syntax element, and the coding tree unit level fourth syntax element.

In some embodiments, the related syntax element further includes a fifth syntax element, and the fifth syntax element is set according to whether the current image block is allowed to use the neural network based in-loop filtering technology. If determining, according to the fifth syntax element, that it is allowed to use the neural network based in-loop filtering technology, a related syntax element is parsed subsequently to determine whether to perform a geometric transformation on an input and determine a geometric transformation type. If determining, according to the fifth syntax element, it is not allowed to use the neural network based in-loop filtering technology, another filtering technology is used, or no filtering technology is used.

In some embodiments, the fifth syntax element includes at least one of the following: an image sequence level fifth syntax element, used to indicate whether an image sequence is allowed to use the neural network based in-loop filtering technology; an image level fifth syntax element, used to indicate whether an image is allowed to use the neural network based in-loop filtering technology; a slice level fifth syntax element, used to indicate whether a slice is allowed to use the neural network based in-loop filtering technology; or a coding tree unit level fifth syntax element, used to indicate whether a coding tree unit is allowed to use the neural network based in-loop filtering technology.

In some embodiments, the fifth syntax element includes the image sequence level fifth syntax element. In some embodiments, the fifth syntax element includes the image sequence level fifth syntax element and an image level fifth syntax element. In some embodiments, the fifth syntax element includes the image sequence level fifth syntax element and the slice level fifth syntax element. In some embodiments, the fifth syntax element includes the image sequence level fifth syntax element, the image level (or slice level) fifth syntax element, and the coding tree unit level fifth syntax element.

Exemplarily, in some embodiments, the reference sample information further includes a constant parameter and a non-constant parameter of a current tree coding unit. The constant parameter comprises at least one of the following: a quantization parameter, or an image type or a slice type corresponding to the current coding tree unit. The non-constant parameter includes at least one of the following: boundary strength information of the current coding tree unit, partitioning information of the current coding tree unit, or reconstructed sample information of a coding tree unit that is corresponding to the current coding tree unit and is in a reference image.

The constant parameter may be understood as a parameter common to all pixels in the current coding tree unit. The non-constant parameter may be understood as a parameter not common to all pixels in the current coding tree unit. Performing geometric transformation on the reference sample information of the current coding tree unit includes performing geometric transformation on all non-constant parameters in the reference sample information.

In some embodiments, the reference sample information further comprises candidate constant parameters of the current coding tree unit; and the method further includes: the method further comprises: determining, according to first distortion cost values of a current image block respectively corresponding to the candidate geometric transformation types, a target constant parameter of the current image block in which the current coding tree unit is located.

In some embodiments, the method further includes: determining whether to adjust a constant parameter of the current image block in which the current coding tree unit is located and setting a sixth syntax element, according to the target constant parameter of the current image block in which the current coding tree unit is located,; and setting a seventh syntax element according to the target constant parameter of the current image block in which the current coding tree unit is located, when determining to adjust the constant parameter of the current image block in which the current coding tree unit is located.

Herein, the target constant parameter may be understood as a constant parameter corresponding to a minimum distortion cost value determined from candidate constant parameters. When the target constant parameter is different from the original constant parameter of the current image block, it is determined to adjust the original constant parameter of the current image block; otherwise, the original constant parameter is not adjusted. In some embodiments, the seventh syntax element value may be set according to a difference between the target constant parameter and the original constant parameter of the current image block.

In some embodiments, the sixth syntax element includes at least one of the following: an image sequence level sixth syntax element, used to indicate whether to adjust the constant parameter of a coding tree unit in an image sequence; an image level sixth syntax element, used to indicate whether to adjust the constant parameter of a coding tree unit in an image; a slice level sixth syntax element, used to indicate whether to adjust the constant parameter of a coding tree unit in a slice; or a coding tree unit level sixth syntax element, used to indicate whether to adjust the constant parameter of a coding tree unit.

In some embodiments, the sixth syntax element includes the image sequence level sixth syntax element. In some embodiments, the sixth syntax element includes the image sequence level sixth syntax element and an image level sixth syntax element. In some embodiments, the sixth syntax element includes the image sequence level sixth syntax element and the slice level sixth syntax element. In some embodiments, the sixth syntax element includes the image sequence level sixth syntax element, the image level (or slice level) sixth syntax element, and the coding tree unit level sixth syntax element.

The seventh syntax element includes one of the following: an image sequence level seventh syntax element, used to indicate an adjusted constant parameter for all coding tree units in an image sequence; a seventh syntax element of an image level, used to indicate an adjusted constant parameter for all coding tree units in an image; a slice level seventh syntax element, used to indicate an adjusted constant parameter for all coding tree units in a slice; or a coding tree unit level seventh syntax element, used to indicate an adjusted constant parameter for a coding tree unit.

In some embodiments, the method further includes: setting the sixth syntax element according to a target constant parameter of a current image block in which a current coding tree unit is located.

In some embodiments, the method further includes: in a case that a time domain level of the current coding tree unit is greater than or equal to a time domain level threshold, determining the geometric transformation type of the current coding tree unit according to the first distortion cost values of the current coding tree unit respectively corresponding to the candidate geometric transformation types; in a case that the time domain level of the current coding tree unit is less than the time domain level threshold, determining not to use a neural network based in-loop filtering technology with performing the geometric transformation on an input.

Exemplarily, in some embodiments, the current coding tree unit is a largest coding unit, or is obtained by changing a size of a largest coding unit. That is, in the foregoing geometric transformation, patchWidth and patchHeight are sizes of a block inputted into the model, which may be the sizes of the coding tree unit, or may be the sizes of a larger patch block obtained by padding outside of a coding tree unit.

The coding tree unit is inputted the neural network in-loop filtering module, and a flag of enabling the neural network based in-loop filter is obtained, that is, sps_nnlf_enable_flag. If the flag is true, the neural network based in-loop filtering technology is allowed to be used. If the flag is false, the neural network based in-loop filtering technology is not allowed. The sequence level enabling flag is written into the bitstream when encoding a video sequence. Herein, the technology in the present disclosure may add a sequence level enabling flag, for example, the new syntax element sps_nnlf_geotransform_enable_flag. The naming of the syntax element herein is mainly used for convenience of understanding, and may be modified in an actual application and a standard text. However, semantic meaning of the syntax element should be consistent or similar, that is, if the flag is true, the neural network based in-loop filter with geometric transformation on model input proposed in the present disclosure is allowed to be used. If the flag is false, the neural network based in-loop filter with geometric transformation on model input proposed in the present disclosure is not allowed to be used.

1. If the flag of enabling the neural network based in-loop filter is true, the encoding side attempts to use the technology of the neural network based in-loop filter, that is, performing 2. If the flag of enabling the neural network based in-loop filter is false, the encoding side does not attempt to use the technology of the neural network based in-loop filter, that is, skipping 2 and directly performing 3.

2. Initialize the neural network based in-loop filtering technology and load a neural network model applicable to the current image.

a. Calculate the cost of a reconstructed sample.

The encoding side calculates the cost information obtained not based on the neural network based in-loop filtering technology, that is, the encoding side calculates and records the rate distortion cost value by using reconstructed sample of the coding tree unit prepared as the network input and the original image sample of the coding tree unit. The rate distortion cost value mainly includes a sum of absolute differences and a quantity of consumed bits. The encoder traverses and calculates costs of all the coding tree units in the current image or slice, and records and accumulates them to obtain costRec, where the cost information costRec represents an accumulated cost of all the coding tree units in the current image or slice.

b. Filter and calculate the costs of various geometric transformed inputs being inputted into the model

The encoding side attempts to use the neural network based in-loop filtering technology, by inputting the reconstructed sample rec, predicted sample pred, quantization parameter BaseQP, quantization parameter SliceQP, and image or slice type SliceType of the current coding tree unit into the loaded model for inference. The neural network based in-loop filter model outputs the reconstructed sample of the current coding tree unit, calculates the rate distortion cost value of the filtered reconstructed sample and the original image sample of the current coding tree unit, and records the rate distortion cost value. The encoder traverses and calculates cost information of all coding tree units in the current image or slice, records and accumulates them to obtain costOrgM. CostOrgM represents an accumulated cost of all coding tree units in the current image or slice.

If the current image or the slice type is allowed to use the technology of performing geometric transformation on a model input proposed in the present disclosure, the remaining steps are performed; otherwise, the remaining steps are skipped, and the costOrgM is assigned to costCnn, and 2.c is performed.

The encoding side continues to attempt to use the neural network based in-loop filtering technology by horizontally flipping the reconstructed sample rec and the predicted sample pred of the current coding tree unit, and inputting them together with the quantization parameter BaseQP, quantization parameter SliceQP, and image or slice type SliceType information into the loaded model for inference. The neural network based in-loop filter model outputs the reconstructed sample of the current coding tree unit, calculates the rate distortion cost value of the reconstructed sample obtained by filtering the current coding tree unit and the original image sample, and records the rate distortion cost value. The encoder traverses and calculates the cost information of all the coding tree units in the current image or slice, records and accumulates them to obtain costHorflipM. The costHorflipM also represents an accumulated cost of all the coding tree units in the current image or slice.

Similar to the foregoing steps, accumulated costs of all coding tree units in the current image or slice are obtained respectively by means of filtering and calculation based on vertical flip and diagonal flip. Herein, the costs are respectively denoted as costVerflipM and costTranspM.

The values of the costOrgM, the costHorflipM, the costVerflipM, and the costTranspM are compared with each other. In this embodiment, it is assumed that the index for the horizontal flip is 0, the index for the vertical flip is 1, and the index for the diagonal flip is 2. If costOrgM is the least, it indicates that the original filtering without using the geometric transformed model input has the best general performance for the current image or slice, and thus slice_nnlf_geotransform_flag is set to false. Otherwise, it indicates that a geometric transformed model input has a better performance, and thus slice_nnlf_geotransform_flag is set to true, and the index corresponding to the geometric transformation type with the least cost is assigned to slice_nnlf_geotransform_index.

The value of the least cost in the foregoing comparison is assigned to the costCnn as the minimum cost information of using the neural network based in-loop filtering for all the coding tree units in the image or slice level.

C. Decide Final Information of the Neural Network Based in-Loop Filtering Module

The encoding side attempts to find the optimal selection in the coding tree unit level. In the second round of attempting to use the neural network based in-loop filter, the encoding side directly determines by default to use the neural network based in-loop filtering technology for all the coding tree units in the current image, and uses an image or slice level flag slice_nnlf_flag for control, while the coding tree unit level does not need to transmit the using flag ctb_nnlf_flag. Now the coding tree unit level switch combination are tried, that is, each coding tree unit has an independent flag.

The encoder traverses the coding tree units, and compares the costs of each coding tree unit obtained by using and not using the neural network based in-loop filtering technology. If the cost corresponding to not filtering is less, the flag ctb_nnlf_flag of the respective coding tree unit is set to false. Otherwise, the flag ctb_nnlf_flag of the respective coding tree unit is set to true. After all the coding tree units are traversed by the encoder, the minimum costs of all coding tree units are accumulated to obtain a rate distortion cost value costCtu of the current image or slice, and costCtu represents an accumulated value of minimum costs of all the coding tree units in the current image or slice. In addition, if the current image or slice is allowed to use the techniques of multiple geometric transformed model inputs proposed herein, the neural network based in-loop filter model input of all coding tree units in the current image or slice is determined according to slice_nnlf_geotransform_flag and slice_nnlf_geotransform_index. If the current image or slice is not allowed to use the techniques of multiple geometric transformed model inputs proposed herein, input of all coding tree units in the current image or slice are original untransformed samples.

If costRec is the least, it indicates that it is better for the current image or slice not to use the neural network based in-loop filtering technology. The image or slice level flag slice_nnlf_flag is set to 0 and is written into the bitstream for transmission to the decoding side. This indicates that all the coding tree units in the current image or slice do not use the neural network based in-loop filtering technology, and the coding tree unit level flag does not need to be written into the bitstream.

If costCnn is the least, it indicates that it is better for all the coding tree units in the current image or slice to use the neural network based in-loop filtering technology. The image or slice level flag slice_nnlf_flag is set to 1 and is written into the bitstream for transmission to the decoding side, and the coding unit level flag ctb_nnlf_flag does not need to be written into the bitstream. In addition, if the current image or slice is allowed to use the technologies of multiple geometric transformed model inputs proposed in the present disclosure, the slice_nnlf_geotransform_flag needs to be written into the bitstream for transmission to the decoding side. If the slice_nnlf_geotransform_flag is true, the slice_nnlf_geotransform_index needs to be written to the bitstream for transmission to the decoding side.

If costCtu is the least, it indicates that not all coding tree units in the current image or slice use the neural network based in-loop filtering technology, and the image or slice level flag slice_nnlf_flag is set to 2 and written into the bitstream for transmission to the decoding side. In addition, the neural network based in-loop filtering technology using flag ctb_nnlf_flag of each coding tree unit needs to be written into the bitstream, where the determination of true or false of the flag is described in the foregoing. In addition, if the current image or slice is allowed to use the technologies of multiple geometric transformed model inputs proposed in the present disclosure, the slice_nnlf_geotransform_flag needs to be written into the bitstream for transmission to the decoding side. If the slice_nnlf_geotransform_flag is true, the slice_nnlf_geotransform_index needs to be written into the bitstream for transmission to the decoding side.

3. The encoder continues to try other in-loop filtering tools, and outputs the final complete reconstructed image. The specific process is not related to the technology in the present disclosure. Therefore, the details are not described herein.

In this embodiment, the coding tree unit level may have different parameter adjustments, and the parameter adjustments are usually applied to constant inputs of the model. For example, both the introduced first and second neural network based in-loop filter solutions have constant input information, including quantization parameter information, a current image or slice type information, and the like. This embodiment focuses on a coupling application between parameter adjustment of the constant input and the technology provided in the present disclosure, which may be combined.

Specifically, the first neural network based in-loop filter solution is used as an example to adjust the quantization parameter BaseQP that is input into the model according to a preset step size or offset value or compensation value or candidate value. In this embodiment, a compensation value is used as an example, and adjustment calculation is as follows:

$$FinalBaseQP = BaseQP + offset$$

In the foregoing calculation formula, FinalBaseQP is the quantization parameter BaseQP that is finally inputted into the model, and offset is a quantization parameter compensation value (that is, an adjustment parameter), and may be 0, +5,−5, +10,−10, or the like.

For example, newly added syntax elements may be as follows: an image or slice level sixth syntax element, slice_nnlf_qpadj_flag (an image or slice level QP adjustment flag); and an image or slice level seventh syntax element, slice_nnlf_qpadj_index (an image level or slice level QP adjustment flag).

The encoder performs prediction on a current image to obtain a prediction block of each coding unit, and may obtain a residual of the coding unit by obtaining a difference between the original image block and the prediction block. The residual may be transformed in various transform mode, to obtain the frequency domain residual coefficients, which then passes through the quantization, inverse quantization, inverse transformation, to obtain the distortion residual information. By adding the distortion residual information and the prediction block, the reconstructed block can be obtained. The reconstructed block herein generally refers to the reconstructed sample coding unit obtained from the predicted sample added to the residual sample that is inversed quantized and inverse transformed. Then, the in-loop filter module performs filtering on the image in the basic unit of the coding tree unit level, where the technical solution proposed in the present disclosure is applied.

The coding tree unit is inputted the neural network in-loop filtering module, and a flag of enabling the neural network based in-loop filter is obtained, that is, sps_nnlf_enable_flag. If the flag is true, the neural network based in-loop filtering technology is allowed to be used. If the flag is false, the neural network based in-loop filtering technology is not allowed. The sequence level enabling flag is written into the bitstream when encoding a video sequence. Herein, the technology in the present disclosure may add a sequence level enabling flag, for example, the new syntax element sps_nnlf_geotransform_enable_flag. The naming of the syntax element herein is mainly used for convenience of understanding, and may be modified in an actual application and a standard text. However, semantic meaning of the syntax element should be consistent or similar, that is, if the flag is true, the neural network based in-loop filter with geometric transformation on model input proposed in the present disclosure is allowed to be used. If the flag is false, the neural network based in-loop filter with geometric transformation on model input proposed in the present disclosure is not allowed to be used.

1. If the flag of enabling the neural network based in-loop filter is true, the encoding side attempts to use the technology of the neural network based in-loop filter, that is, performing 2. If the flag of enabling the neural network based in-loop filter is false, the encoding side does not attempt to use the technology of the neural network based in-loop filter, that is, skipping 2 and directly performing 3.

2. Initialize the neural network based in-loop filtering technology and load a neural network model applicable to the current image.

### A. Calculate the Cost of A Reconstructed Sample.

The encoding side calculates the cost information obtained not based on the neural network based in-loop filtering technology, that is, the encoding side calculates and records the rate distortion cost value by using reconstructed sample of the coding tree unit prepared as the network input and the original image sample of the coding tree unit. The rate distortion cost value mainly includes a sum of absolute differences and a quantity of consumed bits. The encoder traverses and calculates costs of all the coding tree units in the current image or slice, and records and accumulates them to obtain costRec, where the cost information costRec represents an accumulated cost of all the coding tree units in the current image or slice.

B. Filter and Calculate the Costs of Various Geometric Transformed Inputs being Inputted into the Model

The encoding side attempts to use the neural network based in-loop filtering technology, by inputting the reconstructed sample rec, predicted sample pred, quantization parameter BaseQP, quantization parameter SliceQP, and image or slice type SliceType of the current coding tree unit into the loaded model for inference. The neural network based in-loop filter model outputs the reconstructed sample of the current coding tree unit, calculates the rate distortion cost value of the filtered reconstructed sample and the original image sample of the current coding tree unit, and records the rate distortion cost value. The encoder traverses and calculates cost information of all coding tree units in the current image or slice, records and accumulates them to obtain costOrgQP0. The costOrgQP0 represents an accumulated cost of all coding tree units in the current image or slice.

The encoding side continues to attempt to use the neural network based in-loop filtering technology by adjusting the constant information of the model input and filtering all the coding tree units in the current image or slice. The reconstructed sample rec and the predicted sample pred of the to-be-filtered coding tree unit, the compensated quantization parameter FinalBaseQP (BaseQP−5), the quantization parameter SliceQP, and the image or slice type SliceType are input into the loaded model for inference filtering. The neural network based in-loop filter model outputs the reconstructed sample of the current coding tree unit, calculates the rate distortion cost value of the reconstructed sample obtained by filting the current coding tree unit and the original image sample, and records the rate distortion cost value. The encoder traverses and calculates the cost information of all the coding tree unit in the current image or slice, records and accumulates them to obtain costOrgQP1. The costOrgQP1 represents an accumulated cost of all coding tree units in the current image or slice.

The encoding side continues to attempt to use the neural network based in-loop filtering technology by adjusting the constant information of the model input and filtering all the coding tree units in the current image or slice. The reconstructed sample rec and the predicted sample pred of the to-be-filtered coding tree unit, the compensated quantization parameter FinalBaseQP (BaseQP+5), the quantization parameter SliceQP, and the image or slice type SliceType are input into the loaded model for inference filtering. The neural network based in-loop filter model outputs the reconstructed sample of the current coding tree unit, calculates the rate distortion cost value of the reconstructed sample obtained by filting the current coding tree unit and the original image sample, and records the rate distortion cost value. The encoder traverses and calculates the cost information of all the coding tree unit in the current image or slice, records and accumulates them to obtain costOrgQP2. The costOrgQP2 represents an accumulated cost of all coding tree units in the current image or slice.

The values of costOrgQP0, costOrgQP1, and costOrgQP2 are compared with each other. If costOrgQP0 is the least, slice_nnlf_qpadj_flag is set to false, indicating that parameter adjustment is not used for the current image or slice. Otherwise, slice_nnlf_qpadj_flag is set to true, indicating that that parameter adjustment is used for the current image or slice. In addition, the slice_nnlf_qpadj_index needs to be set according to the values of costOrgQP1 and costOrgQP2. If costOrgQP1 is less than or equal to costOrgQP2, slice_nnlf_qpadj_index is set to 0, otherwise, slice_nnlf_qpadj_index is set to 1.

The least value among costOrgQP0, costOrgQP1 and costOrgQP2 is assigned to costOrgM.

If the current image or the slice type is allowed to use the technology of performing geometric transformation on a model input proposed in the present disclosure, the remaining steps are performed; otherwise, the remaining steps are skipped, and the costOrgM is assigned to costCnn, and 2.c is performed.

The encoding side continues to attempt to use the neural network based in-loop filtering technology by horizontally flipping the reconstructed sample rec and the predicted sample pred of the current coding tree unit, and inputting them together with the quantization parameter BaseQP, quantization parameter SliceQP, and image or slice type SliceType information into the loaded model for inference. The neural network based in-loop filter model outputs the reconstructed sample of the current coding tree unit, calculates the rate distortion cost value of the reconstructed sample obtained by filtering the current coding tree unit and the original image sample, and records the rate distortion cost value. The encoder traverses and calculates the cost information of all the coding tree units in the current image or slice, records and accumulates them to obtain costHorflipM. The costHorflipM also represents an accumulated cost of all the coding tree units in the current image or slice. The quantization parameter information BaseQP input into the model needs to be adjusted according to slice_nnlf_qpadj_flag and slice_nnlf_qpadj_index.

Similar to the foregoing steps, accumulated costs of all coding tree units in the current image or slice are obtained respectively by means of filtering and calculation based on vertical flip and diagonal flip. Herein, the costs are respectively denoted as costVerflipM and costTranspM.

The values of the costOrgM, the costHorflipM, the cost VerflipM, and the costTranspM are compared with each other. In this embodiment, it is assumed that the index for the horizontal flip is 0, the index for the vertical flip is 1, and the index for the diagonal flip is 2. If costOrgM is the least, it indicates that the original filtering without using the geometric transformed model input has the best general performance for the current image or slice, and thus slice_nnlf_geotransform_flag is set to false. Otherwise, it indicates that a geometric transformed model input has a better performance, and thus slice_nnlf_geotransform_flag is set to true, and the index corresponding to the geometric transformation type with the least cost is assigned to slice_nnlf_geotransform_index.

The value of the least cost in the foregoing comparison is assigned to the costCnn as the minimum cost information of using the neural network based in-loop filtering for all the coding tree units in the image or slice level.

C. Decide Final Information of the Neural Network Based in-Loop Filtering Module

The encoding side attempts to find the optimal selection in the coding tree unit level. In the second round of attempting to use the neural network based in-loop filter, the encoding side directly determines by default to use the neural network based in-loop filtering technology for all the coding tree units in the current image, and uses an image or slice level flag slice_nnlf_flag for control, while the coding tree unit level does not need to transmit the using flag ctb_nnlf_flag. Now the coding tree unit level switch combination are tried, that is, each coding tree unit has an independent flag.

The encoder traverses the coding tree units, and compares the costs of each coding tree unit obtained by using and not using the neural network based in-loop filtering technology. If the cost corresponding to not filtering is less, the flag ctb_nnlf_flag of the respective coding tree unit is set to false. Otherwise, the flag ctb_nnlf_flag of the respective coding tree unit is set to true. After all the coding tree units are traversed by the encoder, the minimum costs of all coding tree units are accumulated to obtain a rate distortion cost value costCtu of the current image or slice, where the costCtu represents an accumulated value of minimum costs of all the coding tree units in the current image or slice. In addition, if the current image or slice is allowed to use the techniques of multiple geometric transformed model inputs proposed herein, the neural network based in-loop filter model input of all coding tree units in the current image or slice is determined according to slice_nnlf_geotransform_flag and slice_nnlf_geotransform_index. If the current image or slice is not allowed to use the techniques of multiple geometric transformed model inputs proposed herein, input of all coding tree units in the current image or slice are original untransformed samples. In addition, the model input of quantization parameter BaseQP to the filtering process also needs to be determined according to slice_nnlf_qpadj_flag and slice_nnlf_qpadj_index that are determined in 2.b.

If costRec is the least, it indicates that it is better for the current image or slice not to use the neural network based in-loop filtering technology. The image or slice level flag slice_nnlf_flag is set to 0 and is written into the bitstream for transmission to the decoding side. This indicates that all the coding tree units in the current image or slice do not use the neural network based in-loop filtering technology, and the coding tree unit level flag does not need to be written into the bitstream.

If costCnn is the least, it indicates that it is better for all the coding tree units in the current image or slice to use the neural network based in-loop filtering technology. The image or slice level flag slice_nnlf_flag is set to 1 and is written into the bitstream for transmission to the decoding side, and the coding unit level flag ctb_nnlf_flag does not need to be written into the bitstream. The slice_nnlf_qpadj_flag is written into the bitstream for transmission to the decoding side. If slice_nnlf_qpadj_flag is true, slice_nnlf_qpadj_index is written into the bitstream for transmission to the decoding side. In addition, if the current image or slice is allowed to use the technologies of multiple geometric transformed model inputs proposed in the present disclosure, the slice_nnlf_geotransform_flag is written into the bitstream for transmission to the decoding side. If the slice_nnlf_geotransform_flag is true, the slice_nnlf_geotransform_index is written into the bitstream for transmission to the decoding side.

If costCtu is the least, it indicates that not all coding tree units in the current image or slice use the neural network based in-loop filtering technology, and the image or slice level flag slice_nnlf_flag is set to 2 and written into the bitstream for transmission to the decoding side. In addition, the neural network based in-loop filtering technology using flag ctb_nnlf_flag of each coding tree unit needs to be written into the bitstream, where the determination of true or false of the flag is described in the foregoing. The slice_nnlf_qpadj_flag is written into the bitstream for transmission to the decoding side. If the slice_nnlf_qpadj_flag is true, the slice_nnlf_qpadj_index is written into the bitstream for transmission to the decoding side. In addition, if the current image or slice is allowed to use the technologies of multiple geometric transformed model inputs proposed in the present disclosure, the slice_nnlf_geotransform_flag is written into the bitstream for transmission to the decoding side. If the slice_nnlf_geotransform_flag is true, the slice_nnlf_geotransform_index is written into the bitstream for transmission to the decoding side.

3. The encoder continues to try other in-loop filtering tools, and outputs the final complete reconstructed image. The specific process is not related to the technology in the present disclosure. Therefore, the details are not described herein.

In this technical solution, no new model is added, and whether to use the input geometric transformation is determined by rate distortion optimization calculation of the encoding side. The decoding side only needs to parse the bitstream, thereby improving encoding performance. (Negative numbers indicate performance gains)

TABLE 3

| | Random Access Main 10 | | | | |
|---|---|---|---|---|---|
| | Y | U | V | EncT | DecT |
| Class A1 | −0.20% | −0.29% | −0.27% | 191% | 105% |
| Class A2 | −0.32% | −0.91% | −0.52% | 188% | 105% |
| Class B | −0.24% | −0.57% | −0.75% | 184% | 106% |
| Class C | −0.32% | −0.71% | −0.94% | 160% | 106% |
| Class E | | | | | |
| Overall | −0.27% | −0.62% | −0.66% | 179% | 106% |
| Class D | −0.32% | −0.43% | −1.07% | 155% | 106% |
| Class F | −0.21% | −0.70% | −0.63% | 218% | 109% |
| Class TGM | #VALUE! | #VALUE! | #VALUE! | #DIV/0! | #DIV/0! |

TABLE 4

| | Low Delay B Main 10 | | | | |
|---|---|---|---|---|---|
| | Y | U | V | EncT | DecT |
| Class A1 | | | | | |
| Class A2 | | | | | |
| Class B | −0.50% | −1.58% | −1.08% | #NUM! | #NUM! |
| Class C | −0.74% | −2.02% | −2.10% | 155% | 110% |
| Class E | −0.69% | −1.36% | −2.38% | 261% | 142% |
| Overall | −0.63% | −1.78% | −1.53% | #NUM! | #NUM! |
| Class D | −0.63% | −1.15% | −1.41% | 150% | 110% |
| Class F | −0.44% | −1.45% | −0.45% | #NUM! | #NUM! |
| Class TGM | #VALUE! | #VALUE! | #VALUE! | #DIV/0! | #DIV/0! |

According to the experimental results, the proposed method improves the encoding performance of all color components under both the test conditions of Random Access and Low Delay B. In terms of the decoding time, the proposed solution basically does not affect the decoding time, which fluctuates slightly.

The scaling operation is not described in detail in the foregoing embodiments, which does not represent that the scaling operation cannot be used in this technical solution. The scaling operation may be used for the output of the neural network model, i.e., scaling the residual that is obtained as a difference between the filtered reconstructed sample obtained by the neural network and the unfiltered reconstructed sample.

In the foregoing embodiments, it is not indicated whether the method is used for a luma component or a chroma component, because all the methods proposed in the present disclosure are applicable to both the luma component and the chroma component, this is not limited herein. It is clear that the syntax element in the present disclosure, for example, ctb_nnlf_flag and slice_nnlf_flag can be used for control separately for the luma component and the chroma component.

In still another embodiment of the present disclosure, an embodiment of the present disclosure further provides a bitstream, where the bitstream is generated by performing bit encoding on to-be-encoded information. The to-be-encoded information includes at least the related syntax element of a current coding tree unit.

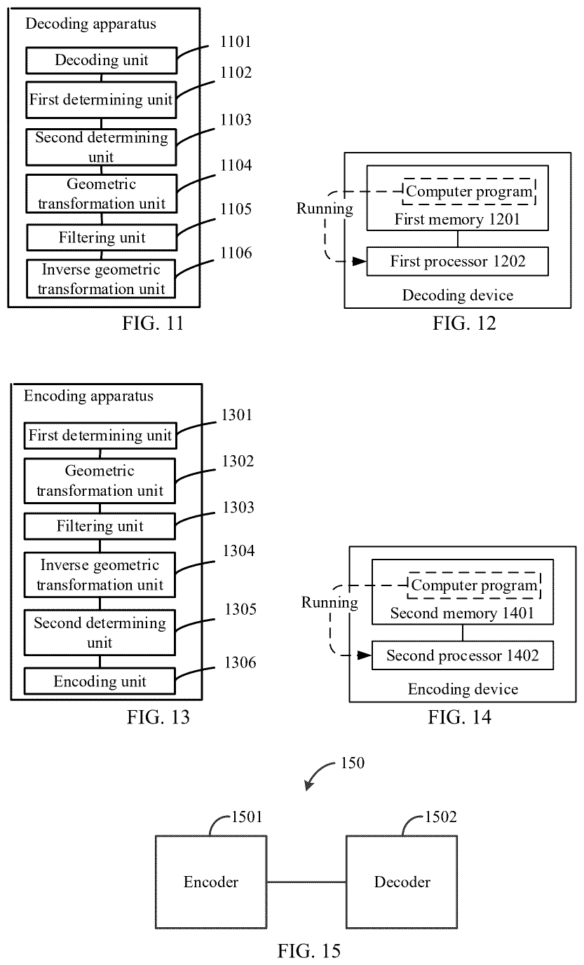

In still another embodiment of the present disclosure, referring to FIG. 11, FIG. 11 shows a schematic structural diagram of a decoding apparatus according to an embodiment of the present disclosure. As shown in FIG. 11, the decoding apparatus may include:
a decoding unit 1101, configured to decode a bitstream to determine a related syntax element of a current coding tree unit;
a first determining unit 1102, configured to determine a geometric transformation type of the current coding tree unit according to the related syntax element;
a second determining unit 1103, configured to determine reference sample information of the current coding tree unit, wherein the reference sample information at least comprises predicted sample information and/or reconstructed sample information of the current coding tree unit;
a geometric transformation unit 1104, configured to perform geometric transformation on the reference sample information of the current coding tree unit according to the geometric transformation type, to obtain geometric transformed reference sample information;
a filtering unit 1105, configured to input the geometric transformed reference sample information of the current coding tree unit to a neural network based in-loop filter model for filtering, to output filtered reconstructed sample information; and
an inverse geometric transformation unit 1106, configured to perform inverse geometric transformation on the filtered reconstructed sample information according to the geometric transformation type, to obtain final reconstructed sample information of the current coding tree unit.

In an actual application, an embodiment of the present disclosure further provides a decoding device. FIG. 12 is a specific schematic structural diagram of hardware of a decoding device according to an embodiment of the present disclosure. As shown in FIG. 12, the decoding device includes: a first memory 1201 and a first processor 1202. The first memory 1201 stores a computer program executable by the first processor 1202, and the first processor 1202, when executing the program, performs the decoding method on the decoder side.

In an actual application, the decoding device may further include a first communications interface, configured to perform transmitting and receiving information with another external network element.

In still another embodiment of the present disclosure, referring to FIG. 13, FIG. 13 shows a schematic structural diagram of an encoding apparatus according to an embodiment of the present disclosure. As shown in FIG. 13, the encoding apparatus may include:
a first determining unit 1301, configured to determine reference sample information of a current coding tree unit, wherein the reference sample information at least comprises predicted sample information and/or reconstructed sample information of the current coding tree unit;
a geometric transformation unit 1302, configured to perform geometric transformation on the reference sample information of the current coding tree unit according to candidate geometric transformation types, to obtain geometric transformed reference sample information;
a filtering unit 1303, configured to input the geometric transformed reference sample information of the current coding tree unit to a neural network based in-loop filter model for filtering, to output filtered reconstructed sample information;
an inverse geometric transformation unit 1304, configured to perform inverse geometric transformation on the filtered reconstructed sample information according to the candidate geometric transformation types, to obtain final reconstructed sample information of the current coding tree unit;
a second determining unit 1305, configured to determine a first distortion cost value of the current coding tree unit according to original sample information and the final reconstructed sample information of the current coding tree unit; and determine a geometric transformation type of the current coding tree unit according to first distortion cost values of the current coding tree unit respectively corresponding to the candidate geometric transformation types; and
an encoding unit 1306, configured to encode a related syntax element to the geometric transformation type of the current coding tree unit, and write an encoded bit into a bitstream.

In an actual application, an embodiment of the present disclosure further provides an encoding device. FIG. 14 is a specific schematic structural diagram of hardware of an encoding device according to an embodiment of the present disclosure. As shown in FIG. 14, the encoding device includes: a second memory 1401 and a second processor 1402. The second memory 1401 stores a computer program executable by the second processor 1402, and the second processor 1402, when executing the program, performs an encoding method on an encoder side when the program is executed.

In an actual application, the decoding device may further include a second communications interface, configured to perform transmitting and receiving information with another external network element.

By using the foregoing apparatus or device, after geometric transformation is performed on the input information, the transformed input information is inputted into the model for inference calculation, and inverse transformation is performed on the output information to obtain reconstructed sample information, thereby fully utilizing the optimal performance of the model, to obtain a better filtering effect than the solution of directly inputting.

In addition, the various functional modules in the embodiments may be integrated into one processing unit, or may exist separately, or two or more units may be integrated into one unit. The foregoing integrated unit may be implemented in a form of hardware, or may be implemented in a form of a software functional module.

In still another embodiment of the present disclosure, referring to FIG. 15, FIG. 15 shows a schematic structural diagram of a coding system according to an embodiment of the present disclosure. As shown in FIG. 15, the coding system 150 may include an encoder 1501 and a decoder 1502. The encoder 1501 may be a device integrated with the encoding apparatus in the foregoing embodiment, or may be the encoding device in the foregoing embodiment. The decoder 1502 may be a device integrated with the decoding apparatus in the foregoing embodiment, or may be the decoding device in the foregoing embodiment.

In this embodiment of the present disclosure, in both the encoder 1501 and the decoder 1502 of the coding system 150, the input information is geometrically transformed, and input to the model for inference calculation, and inverse transformation is performed on the output information to obtain reconstructed sample information, thereby fully utilizing the optimal performance of the model, to obtain a better filtering effect than the solution of directly inputting.

Correspondingly, an embodiment of the present disclosure further provides a computer storage medium, where a computer program is stored, and when the computer program is executed by a first processor, the decoding method of the decoder is implemented. Alternatively, when the computer program is executed by a second processor, the encoding method of the encoder is implemented.

It should be noted herein that the foregoing description of the storage medium and the apparatus embodiment is similar to the foregoing description of the method embodiment, and has a beneficial effect similar to that of the method embodiment. For technical details that are not disclosed in the storage medium and apparatus embodiments of the present disclosure, one may refer to the description of the method embodiments of the present disclosure.

It should be noted that the terms “first” and “second” are used to distinguish between similar objects, and do not intend to describe a specific sequence.

The methods disclosed in the several method embodiments provided in present disclosure may be randomly combined without conflict to obtain new method embodiments. The features disclosed in the several device embodiments provided in present disclosure may be randomly combined without conflict to obtain a new device embodiment. The features disclosed in the several method embodiments and device embodiments provided in present disclosure may be randomly combined without conflict to obtain a new method or device embodiment. The foregoing descriptions are merely specific implementations of the present disclosure, but are not intended to limit the protection scope of the present disclosure. Any change or replacement readily figured out by a person skilled in the art within the technical scope disclosed in the present disclosure shall fall within the protection scope of the present disclosure. Therefore, the protection scope of the present disclosure shall be subject to the protection scope of the claims.

### Industrial Practicality

The present disclosure provides coding method and apparatus, an encoding device, a decoding device, and a storage medium, where the decoding method includes: decoding a bitstream to determine a related syntax element of a current coding tree unit; determining a geometric transformation type of the current coding tree unit according to the related syntax element; performing geometric transformation on the reference sample information of the current coding tree unit according to the geometric transformation type, to obtain geometric transformed reference sample information; inputting the geometric transformed reference sample information of the current coding tree unit to a neural network based in-loop filter model for filtering, to output filtered reconstructed sample information; and performing inverse geometric transformation on the filtered reconstructed sample information according to the geometric transformation type, to obtain final reconstructed sample information of the current coding tree unit. After geometric transformation is performed on the input information, the transformed input information is inputted into the model for inference calculation, and inverse transformation is performed on the output information to obtain reconstructed sample information, thereby fully utilizing the optimal performance of the model, to obtain a better filtering effect than the solution of directly inputting.

What is claimed is:

1. A decoding method, comprising:
decoding a bitstream to determine a related syntax element of a current coding tree unit;
determining a geometric transformation type of the current coding tree unit according to the related syntax element;
determining reference sample information of the current coding tree unit, wherein the reference sample information at least comprises predicted sample information and/or reconstructed sample information of the current coding tree unit;
performing geometric transformation on the reference sample information of the current coding tree unit according to the geometric transformation type, to obtain geometric transformed reference sample information;
inputting the geometric transformed reference sample information of the current coding tree unit to a neural network based in-loop filter model for filtering, to output filtered reconstructed sample information; and
performing inverse geometric transformation on the filtered reconstructed sample information according to the geometric transformation type, to obtain final reconstructed sample information of the current coding tree unit.

2. The method according to claim 1, comprising:
determining, according to a first syntax element, whether a current image block in which the current coding tree unit is located uses a neural network based in-loop filtering technology with performing the geometric transformation on an input.

3. The method according to claim 2, wherein
the first syntax element comprises at least one of following:
an image sequence level first syntax element, used to indicate whether an image sequence uses the neural network based in-loop filtering technology with performing the geometric transformation on the input;
an image level first syntax element, used to indicate whether an image uses the neural network based in-loop filtering technology with performing the geometric transformation on the input;
a slice level first syntax element, used to indicate whether a slice uses the neural network based in-loop filtering technology with performing the geometric transformation on the input; or
a coding tree unit level first syntax element, used to indicate whether a coding tree unit uses the neural network based in-loop filtering technology with performing the geometric transformation on the input.

4. The method according to claim 2, comprising:
determining, according to a second syntax element, the geometric transformation type of the coding tree unit in the current image block, when determining, according to the first syntax element, that the current image block in which the current coding tree unit is located uses the neural network based in-loop filtering technology with performing the geometric transformation on the input.

5. The method according to claim 4, wherein
the second syntax element comprises one of following:
an image sequence level second syntax element, used to indicate a geometric transformation type of all coding tree units in an image sequence;
an image level second syntax element, used to indicate a geometric transformation type of all coding tree units in an image;
a slice level second syntax element, used to indicate a geometric transformation type of all coding tree units in a slice; or
a coding tree unit level second syntax element, used to indicate a geometric transformation type of a coding tree unit.

6. The method according to claim 2, comprising:
determining, according to a third syntax element, whether the current image block uses a neural network based in-loop filtering technology.

7. The method according to claim 6, wherein
the third syntax element comprises at least one of following:
an image sequence level third syntax element, used to indicate whether an image sequence uses the neural network based in-loop filtering technology;
an image level third syntax element, used to indicate whether an image uses the neural network based in-loop filtering technology;
a slice level third syntax element, used to indicate whether a slice uses the neural network based in-loop filtering technology; or
a coding tree unit level third syntax element, used to indicate whether a coding tree unit uses the neural network based in-loop filtering technology.

8. The method according to claim 2, comprising:
determining, according to a fourth syntax element, whether the current image block is allowed to use the neural network based in-loop filtering technology with performing the geometric transformation on the input.

9. The method according to claim 8, wherein
the fourth syntax element comprises at least one of following:
an image sequence level fourth syntax element, used to indicate whether an image sequence is allowed to use the neural network based in-loop filtering technology with performing the geometric transformation on the input;
an image level fourth syntax element, used to indicate whether an image is allowed to use the neural network based in-loop filtering technology with performing the geometric transformation on the input;
a slice level fourth syntax element, used to indicate whether a slice is allowed to use the neural network based in-loop filtering technology with performing the geometric transformation on the input; or
a coding tree unit level fourth syntax element, used to indicate whether a coding tree unit is allowed to use the neural network based in-loop filtering technology with performing the geometric transformation on the input.

10. The method according to claim 2, comprising:
determining, according to a fifth syntax element, whether the current image block is allowed to use a neural network based in-loop filtering technology.

11. The method according to claim 10, wherein
the fifth syntax element comprises at least one of the following:
an image sequence level fifth syntax element, used to indicate whether an image sequence is allowed to use the neural network based in-loop filtering technology;
an image level fifth syntax element, used to indicate whether an image is allowed to use the neural network based in-loop filtering technology;
a slice level fifth syntax element, used to indicate whether a slice is allowed to use the neural network based in-loop filtering technology; or
a coding tree unit level fifth syntax element, used to indicate whether a coding tree unit is allowed to use the neural network based in-loop filtering technology.

12. The method according to claim 1, wherein the reference sample information further comprises a constant parameter, and the method further comprises:
determining, according to a sixth syntax element, whether to adjust the constant parameter of a current image block in which the current coding tree unit is located;
determining, according to a seventh syntax element, an adjusted constant parameter of the current image block in which the current coding tree unit is located when determining, according to the sixth syntax element, to adjust the constant parameter of the current image block in which the current coding tree unit is located; and
adjusting the constant parameter according to an adjustment parameter, and inputting the adjusted constant parameter to a neural network based in-loop filtering technology.

13. The method according to claim 12, wherein
the sixth syntax element comprises at least one of following:
an image sequence level sixth syntax element, used to indicate whether to adjust the constant parameter of a coding tree unit in an image sequence;
an image level sixth syntax element, used to indicate whether to adjust the constant parameter of a coding tree unit in an image;
a slice level sixth syntax element, used to indicate whether to adjust the constant parameter of a coding tree unit in a slice; or
a coding tree unit level sixth syntax element, used to indicate whether to adjust the constant parameter of a coding tree unit; and
the seventh syntax element includes one of following:
an image sequence level seventh syntax element, used to indicate an adjusted constant parameter for all coding tree units in an image sequence;
a seventh syntax element of an image level, used to indicate an adjusted constant parameter for all coding tree units in an image;
a slice level seventh syntax element, used to indicate an adjusted constant parameter for all coding tree units in a slice; or
a coding tree unit level seventh syntax element, used to indicate an adjusted constant parameter for a coding tree unit.

14. The method according to claim 2, wherein the current image block comprises at least one of following: a current image sequence, a current image, a current slice, or a current coding tree unit.

15. The method according to claim 1, comprising:
in a case that a time domain level of the current coding tree unit is greater than or equal to a time domain level threshold, determining the geometric transformation type of the current coding tree unit according to the related syntax element;
in a case that the time domain level of the current coding tree unit is less than the time domain level threshold, determining not to use a neural network based in-loop filtering technology with performing the geometric transformation on an input.

16. The method according to claim 1, wherein the reference sample information further comprises a constant parameter and a non-constant parameter of the current tree coding unit;
the constant parameter comprises at least one of the following: a quantization parameter, or an image type or a slice type corresponding to the current coding tree unit; and
the non-constant parameter includes at least one of the following: boundary strength information of the current coding tree unit, partitioning information of the current coding tree unit, or reconstructed sample information of a coding tree unit that is corresponding to the current coding tree unit and is in a reference image.

17. The method according to claim 1, wherein the geometric transformation type comprises one of following: diagonal flip, horizontal flip, vertical flip, or rotation by a preset angle.

18. The method according to claim 1, wherein the current coding tree unit is a largest coding unit, or is obtained by changing a size of a largest coding unit.

19. An encoding method, comprising:
determining reference sample information of a current coding tree unit, wherein the reference sample information at least comprises predicted sample information and/or reconstructed sample information of the current coding tree unit;
performing geometric transformation on the reference sample information of the current coding tree unit according to candidate geometric transformation types, to obtain geometric transformed reference sample information;
inputting the geometric transformed reference sample information of the current coding tree unit to a neural network based in-loop filter model for filtering, to output filtered reconstructed sample information;
performing inverse geometric transformation on the filtered reconstructed sample information according to the candidate geometric transformation types, to obtain final reconstructed sample information of the current coding tree unit;
determining a first distortion cost value of the current coding tree unit according to original sample information and the final reconstructed sample information of the current coding tree unit;
determining a geometric transformation type of the current coding tree unit according to first distortion cost values of the current coding tree unit respectively corresponding to the candidate geometric transformation types; and
encoding a related syntax element to the geometric transformation type of the current coding tree unit, and writing an encoded bit into a bitstream.

20. A decoding apparatus, comprising a processor configured to:
decode a bitstream to determine a related syntax element of a current coding tree unit;
determine a geometric transformation type of the current coding tree unit according to the related syntax element;
determine reference sample information of the current coding tree unit, wherein the reference sample information at least comprises predicted sample information and/or reconstructed sample information of the current coding tree unit;
perform geometric transformation on the reference sample information of the current coding tree unit according to the geometric transformation type, to obtain geometric transformed reference sample information;
input the geometric transformed reference sample information of the current coding tree unit to a neural network based in-loop filter model for filtering, to output filtered reconstructed sample information; and
perform inverse geometric transformation on the filtered reconstructed sample information according to the geometric transformation type, to obtain final reconstructed sample information of the current coding tree unit.
